(19) United States
(12) Patent Application Publication
(10) Pub. No.: US 2020/0379365 A1
(43) Pub. Date: Dec. 3, 2020

(54) ELECTROSTATIC LATENT IMAGE DEVELOPING TONER

(71) Applicant: Konica Minolta, Inc., Tokyo (JP)

(72) Inventors: Aya SHIRAI, Tokyo (JP); Noboru UEDA, Tokyo (JP); Takaki KAWAMURA, Tokyo (JP); Yusuke TAKIGAURA, Tokyo (JP); Natsuki ITO, Tokyo (JP); Ami MOTOHASHI, Tokyo (JP)

(21) Appl. No.: 16/884,817

(22) Filed: May 27, 2020

(30) Foreign Application Priority Data
May 31, 2019 (JP) 2019-103366

(51) Int. Cl. G03G 9/097; G03G 9/087

(52) U.S. Cl. CPC G03G 9/09733; G03G 9/08755; G03G 9/08711

(57) ABSTRACT

An object of the present invention is to provide a new electrostatic latent image developing toner capable of suppressing adhesiveness of a release agent to a member such as a roller or the like and capable of suppressing gloss unevenness and gloss memory.

An electrostatic latent image developing toner containing a binder resin, a release agent, and a colorant, wherein the binder resin contains a crystalline resin, the release agent contains a hydrocarbon wax having a branching degree of 3 to 52%, and a top temperature of an exothermic peak during cooling of the electrostatic latent image developing toner measured by a differential scanning calorimetry is within a range of 60 to 85° C.

### TECHNOLOGICAL FIELD

The present invention relates to an electrostatic latent image developing toner.

### BACKGROUND

In recent years, an electrostatic latent image developing toner (hereinafter, simply referred to as a “toner”) that is thermally fixed at a lower temperature is required in an electrophotographic image forming apparatus.

In such a toner, it is required to reduce a melt temperature or a melt viscosity of a binder resin.

Therefore, in the related art, a toner of which low-temperature fixability is improved by adding a crystalline resin such as a crystalline polyester resin as a fixing aid has been proposed (for example, Japanese Patent Application Laid-Open No. 2012-168505).

### SUMMARY

The present inventors found that in a case where the amount of exudation of a release agent into a surface of a toner layer during fixing of a toner is increased by improving meltability of a resin through low-temperature fixing of the toner, when the release agent (crystalline material) is in contact with a member such as a roller or the like in a state in which the release agent is not crystallized in a cooling process after the fixing of the toner, the release agent adheres to the member, or image quality defects such as gloss unevenness, gloss memory, and the like occur.

Therefore, an object of the present invention is to provide a new electrostatic latent image developing toner capable of suppressing adhesiveness of a release agent to a member such as a roller or the like and capable of suppressing gloss unevenness and gloss memory.

To achieve at least one of the abovementioned objects, according to an aspect of the present invention, an electrostatic latent image developing toner reflecting one aspect of the present invention comprises an electrostatic latent image developing toner comprising: a binder resin; a release agent; and a colorant, wherein the binder resin contains a crystalline resin, the release agent contains a hydrocarbon wax having a branching degree of 3 to 52%, and a top temperature of an exothermic peak during cooling of the electrostatic latent image developing toner measured by a differential scanning calorimetry is within a range of 60 to 85° C.

According to the present invention, it is possible to provide a new electrostatic latent image developing toner capable of suppressing adhesiveness of a release agent to a member such as a roller or the like and capable of suppressing gloss unevenness and gloss memory.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a graph showing an example of an exothermic curve obtained by DSC during cooling and its differential curve;

FIG. 2 is a graph showing an example of an exothermic curve obtained by DSC during cooling and its differential curve;

FIG. 3 is a graph showing another example of an exothermic curve obtained by DSC during cooling and its differential curve; and

FIG. 4 is a schematic view illustrating an example of an internal configuration of a printer engine used in examples.

### DETAILED DESCRIPTION OF EMBODIMENTS

Hereinafter, one or more embodiments of the present invention will be described with reference to the drawings. However, the scope of the invention is not limited to the disclosed embodiments.

### Outline of Electrostatic Latent Image Developing Toner

1. An electrostatic latent image developing toner contains a binder resin, a release agent, and a colorant, wherein the binder resin contains a crystalline resin, the release agent contains a hydrocarbon wax having a branching degree of 3 to 52%, and a top temperature of an exothermic peak during cooling of the electrostatic latent image developing toner measured by a differential scanning calorimetry is within a range of 60 to 85° C. According to such a toner, it is possible to provide a new electrostatic latent image developing toner capable of suppressing adhesiveness of a release agent to a member such as a roller or the like and capable of suppressing gloss unevenness and gloss memory.

2. The electrostatic latent image developing toner according to 1 above, wherein the release agent contains the hydrocarbon wax having the branching degree of 5 to 30%.

3. The electrostatic latent image developing toner according to 2 above, wherein the branching degree is 10 to 25%.

4. The electrostatic latent image developing toner according to any one of 1 to 3 above, wherein the binder resin is a styrene-acrylic resin.

5. The electrostatic latent image developing toner according to any one of 1 to 4 above, wherein a half-value width of the exothermic peak is 7° C. or lower.

6. The electrostatic latent image developing toner according to any one of 1 to 5 above, wherein the release agent contains a wax other than the hydrocarbon wax, and a content of the wax other than the hydrocarbon wax is 90% by mass or less with respect to a total mass of the release agent.

7. The electrostatic latent image developing toner according to 6 above, wherein the content of the wax other than the hydrocarbon wax is less than 5% by mass with respect to the total mass of the release agent.

### Electrostatic Latent Image Developing Toner

The electrostatic latent image developing toner of the present invention contains a binder resin, a colorant, and a release agent.

The electrostatic latent image developing toner refers to an aggregate of toner base particles or of toner particles. Here, the toner particle is preferably obtained by adding an external additive to a toner base particle, but a toner base particle itself can be used as a toner particle. In the present invention, a toner base particle, a toner particle, or a toner is simply called a “toner” when there is no need to distinguish them. In a toner containing a crystalline material such as a crystalline resin, a release agent, or the like, the crystalline resin is melted first when the toner is fixed and heated, and the crystalline resin is cooled and crystallized when paper is discharged from a fixing unit.

### Definition of Top Temperature r_{c} of Exothermic Peak During Cooling

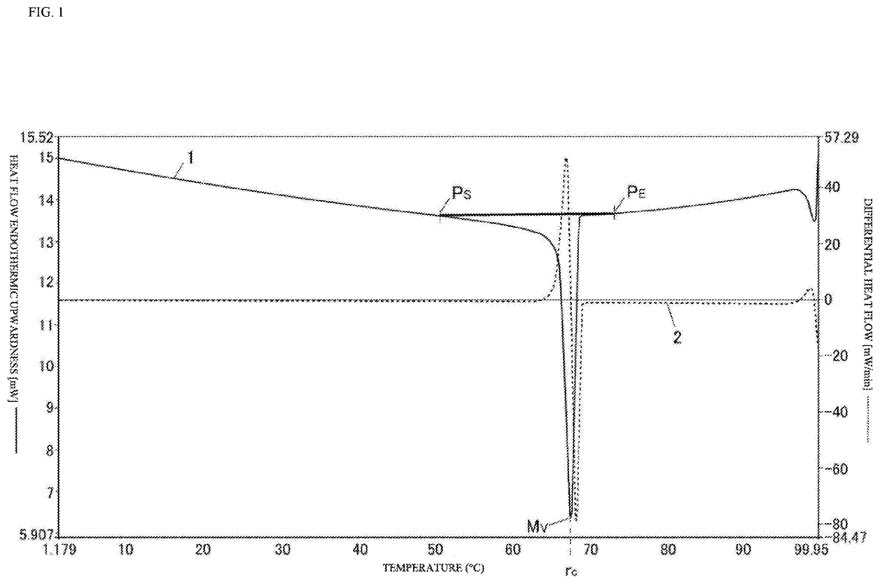

A definition of a top temperature r_{c} of an exothermic peak during cooling will be described with reference to FIGS. 1 to 3. In FIG. 1, a curve 1 is an exothermic curve obtained by DSC during cooling, and a curve 2 is a differential curve of the curve 1 (hereinafter, the curve 2 is referred to as a “differential curve 2”). In the present invention, in the curve 1, a start point and an end point of an exothermic peak are defined as a start point and an end point of changes of slopes of the differential curve 2, respectively.

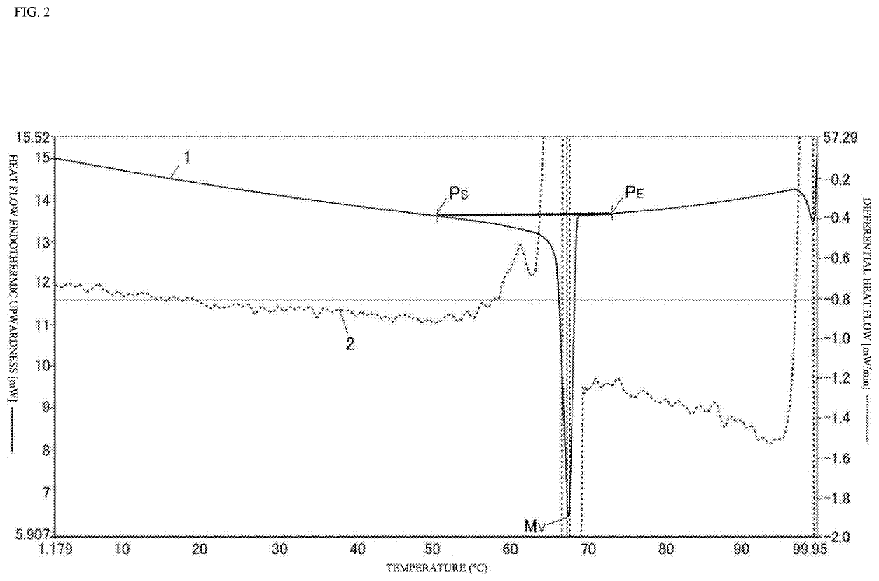

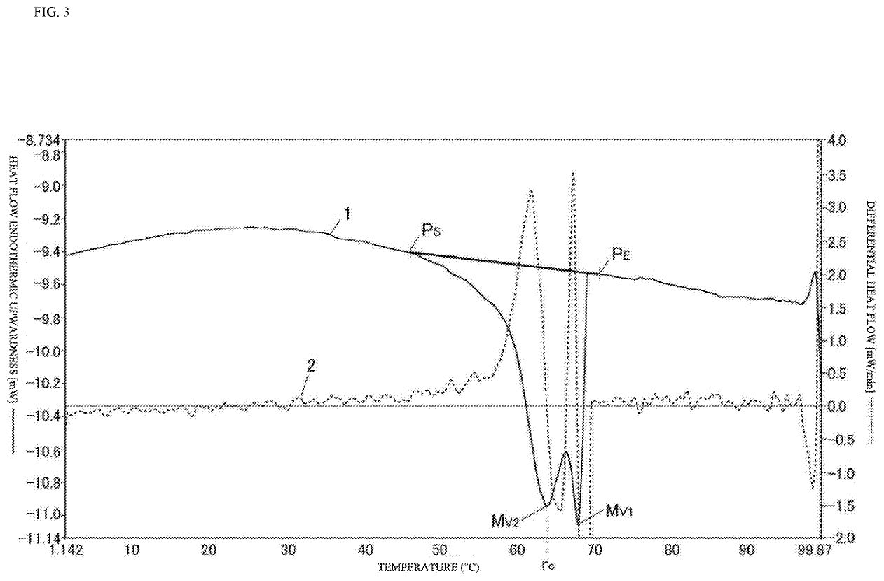

FIG. 2 is an enlarged view of the curve 2. The start point (near 51° C. in the examples of FIGS. 1 and 2) and the end point (near 73° C. in the examples of FIGS. 1 and 2) of the changes of the slopes of the differential curve 2 are defined as a start point Ps and an end point P_{E} of the exothermic peak in the curve 1, respectively. The top temperature r_{c} of the exothermic peak is defined as a temperature of a minimum point M_{V} within a range from the start point P_{S} to the end point P_{E} of the peak as defined above. However, in a case where the minimum point is plural as in the example illustrated in FIG. 3, the lowest temperature peak among the minimum points having an intensity of ⅓ or more of the minimum point having the largest intensity is defined as an exothermic peak top, and the temperature of the exothermic peak top is defined as a top temperature r_{c} of an exothermic peak. Specifically, in the example of FIG. 3, a minimum point M_{V1} having the largest intensity exists near 68° C., but the top temperature r_{c} of the exothermic peak according to the present invention is defined as a temperature of M_{V2} that is a minimum point of a low temperature (near 64° C.).

### Measurement of Top Temperature of Exothermic Peak and Half-Value Width of Exothermic Peak During Cooling

Specifically, 5 mg of a sample is sealed in an aluminum pan (KITNO.B0143013) and is set in a sample holder of a thermal analyzer Diamond DSC (manufactured by PerkinElmer Co., Ltd.), and then the temperature is changed in order of heating, cooling, and heating. During the first and second heating, the temperature is raised from 0° C. to 100° C. at a heating rate of 10° C./min and then the temperature is maintained at 100° C. for 1 minute. During the cooling, the temperature is lowered from 100° C. to 0° C. at a cooling rate of 10° C./min, and then the temperature is maintained at 0° C. for 1 minute. A temperature of an exothermic peak top in an endothermic curve obtained during the cooling is defined as a top temperature r_{c} of an exothermic peak. In addition, a width of the exothermic peak at half a height of a perpendicular line formed by a base line of the endothermic peak and the top temperature r_{c} of the exothermic peak that are obtained during cooling is measured as a half-value width.

The top temperature r_{c} of the exothermic peak during cooling of the electrostatic latent image developing toner of the present invention measured by DSC is within a range of 60 to 85° C., and is preferably within a range of 65 to 80° C.

In an embodiment of the present invention, the top temperature of the exothermic peak during cooling of the toner is 68° C. or higher, 69° C. or higher, 70° C. or higher, 71° C. or higher, 72° C. or higher, 73° C. or higher, 74° C. or higher, 75° C. or higher, 76° C. or higher, 77° C. or higher, 78° C. or higher, or 79° C. or higher. In an embodiment of the present invention, the top temperature of the exothermic peak during cooling of the toner is 84° C. or lower, 83° C. or lower, 82° C. or lower, or 81° C. or lower. When the top temperature rₑ of the exothermic peak is lower than 60° C., the adhesiveness of the release agent to a member such as a roller or the like is excessively increased, and thus, the stated problems cannot be solved. In addition, the problems such as the gloss unevenness and the gloss memory cannot also be solved. In addition, when the top temperature rₑ of the exothermic peak is higher than 85° C., a low-temperature fixability deteriorates. In addition, the adhesiveness of the release agent to a member such as a roller or the like is excessively increased, and thus, the stated problems cannot be solved. In addition, the problem such as the gloss unevenness cannot also be solved.

In an embodiment of the present invention, a predetermined range of the top temperature of the exothermic peak during cooling can be controlled by referring to or combining conventional techniques, but, for example, it is preferable to simultaneously use a hydrocarbon wax having a branching degree of 3 to 52% and a crystalline resin. In addition, it is more preferable that the predetermined range is achieved by using a hydrocarbon wax having a molecular weight of 400 to 800 and/or a melting point of 70 to 90° C. among such hydrocarbon waxes. By doing so, the release agent and the crystalline resin interact with each other to promote crystallization of the release agent and the crystalline resin, and thus, the top temperature of the exothermic peak during cooling of the toner may be set to 60 to 85° C. However, a method for achieving the same is not limited thereto.

In an embodiment of the present invention, the half-value width of the exothermic peak is preferably 7° C. or lower. When the half-value width of the exothermic peak is 7° C. or lower, crystallization of the wax at the time of fixing and discharging can be quickly completed, and adhesion of the wax can thus be suppressed. In an embodiment of the present invention, the half-value width of the exothermic peak may be 3° C. or higher, 4° C. or higher, 5° C. or higher, or 6° C. or higher.

Hereinafter, a constitution requirement of the electrostatic latent image developing toner will be described.

### Binder Resin

In an embodiment of the present invention, the binder resin contains an amorphous resin. In addition, in an embodiment of the present invention, the binder resin contains a crystalline resin.

### Amorphous Resin

Other examples of the amorphous resin can include a vinyl resin, a urethane resin, a urea resin, and an amorphous polyester resin such as a styrene-acrylic modified polyester resin or the like. Among them, a vinyl resin is preferable from the viewpoint of easy control of thermoplasticity.

### Vinyl Resin

The vinyl resin is, for example, a polymer of a vinyl compound, and examples thereof can include an acrylic acid ester resin, a styrene-acrylic acid ester resin, and an ethylene-vinyl acetate resin. Among them, a styrene-acrylic acid ester resin (styrene-acrylic resin) is preferable from the viewpoint of plasticity during thermal fixing.

### Styrene-Acrylic Resin

The binder resin preferably contains at least a styrene-acrylic resin. When the binder resin is the styrene-acrylic resin, excessive exudation of the release agent during fixing can be suppressed, and the adhesion of the wax can be suppressed.

A styrene-acrylic resin is formed by addition polymerization of at least a styrene monomer and a (meth)acrylic acid ester monomer. The styrene monomer includes a styrene derivative having a known side chain or a known functional group in a styrene structure, in addition to styrene represented by a structural formula of CH₂═CH—C₆H₅.

### (Meth)Acrylic Acid Ester Monomer

The (meth)acrylic acid ester monomer includes an acrylic acid ester or a methacrylic acid ester represented by CH(Rₐ)═CHCOOR_{b} (Rₐ represents a hydrogen atom or a methyl group, and R_{b} represents an alkyl group having 1 to 24 carbon atoms) and further includes an acrylic acid ester derivative or a methacrylic acid ester derivative having a known side chain or a known functional group in these ester structures.

Examples of the (meth)acrylic acid ester monomer can include acrylic acid ester monomers such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate, and the like; and methacrylic acid ester monomers such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, dimethylaminoethyl methacrylate, and the like.

In the present specification, the “(meth)acrylic acid ester monomer” is a general term of an “acrylic acid ester monomer” and a “methacrylic acid ester monomer”, and refers to one or both of these monomers. For example, a “methyl (meth)acrylate” refers to one or both of a “methyl acrylate” and a “methyl methacrylate”.

One or more kinds of the (meth)acrylic acid ester monomers may be used. For example, a copolymer can be formed by using a styrene monomer and two or more kinds of acrylic acid ester monomers, by using a styrene monomer and two or more kinds of methacrylic acid ester monomers, or by simultaneously using a styrene monomer, an acrylic acid ester monomer, and a methacrylic acid ester monomer.

### Styrene Monomer

Examples of the styrene monomer can include styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, and p-n-dodecylstyrene.

### Preferred Constitution of Styrene-Acrylic Resin

A content of a constituent unit derived from the styrene monomer in the styrene-acrylic resin is preferably within a range of 40 to 90% by mass, more preferably within a range of 50 to 85% by mass, still more preferably within a range of 60 to 80% by mass, and still more preferably within a range of 65 to 75% by mass, from the viewpoint of controlling plasticity of the styrene-acrylic resin. In addition, a content of a constituent unit derived from the (meth)acrylic acid ester monomer in the styrene-acrylic resin is preferably within a range of 10 to 60% by mass, more preferably within a range of 15 to 50% by mass, still more preferably within a range of 20 to 40% by mass, and still more preferably within a range of 15 to 35% by mass.

### Other Monomers

The styrene-acrylic resin may further contain a constituent unit derived from a monomer other than the styrene monomer and the (meth)acrylic acid ester monomer. The other monomer is preferably a compound that forms an ester bond with a hydroxy group (—OH) derived from a polyhydric alcohol or a carboxy group (—COOH) derived from a polycarboxylic acid. That is, the styrene-acrylic resin is preferably a polymer that can be subjected to addition polymerization with the styrene monomer and the (meth)acrylic acid ester monomer and can be obtained by further polymerization with a compound (amphoteric compound) having a carboxy group or a hydroxy group.

### Amphoteric Compound

Examples of the amphoteric compound can include a compound having a carboxy group such as acrylic acid, methacrylic acid, maleic acid, itaconic acid, cinnamic acid, fumaric acid, maleic acid monoalkyl ester, itaconic acid monoalkyl ester, or the like; and a compound having a hydroxy group such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, polyethylene glycol mono(meth)acrylate, or the like.

### Preferred Content of Constituent Unit Derived from Amphoteric Compound

A content of a constituent unit derived from the amphoteric compound in the styrene-acrylic resin is preferably within a range of 0.5 to 20% by mass, and more preferably within a range of 5 to 10% by mass.

In an embodiment of the present invention, in the styrene-acrylic resin, a total of ratios of the content of the constituent unit derived from the styrene monomer, the content of the constituent unit derived from the (meth)acrylic acid ester monomer, and the content of the constituent unit derived from the amphoteric compound is 100% by mass.

### Synthetic Method of Styrene-Acrylic Resin

The styrene-acrylic resin can be synthesized by a method of polymerizing monomers by using a known oil-soluble or water-soluble polymerization initiator. Examples of the oil-soluble polymerization initiator can include an azo-based or diazo-based polymerization initiator and a peroxide-based polymerization initiator.

### Azo-Based or Diazo-Based Polymerization Initiator

Examples of the azo-based or diazo-based polymerization initiator can include 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

### Peroxide-Based Polymerization Initiator

Examples of the peroxide-based polymerization initiator can include benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl)propane, and tris-(t-butylperoxy)triazine.

### Water-Soluble Radical Polymerization Initiator

In addition, when resin particles of the styrene-acrylic resin are synthesized by an emulsion polymerization method, a water-soluble radical polymerization initiator can be used as the polymerization initiator. Examples of the water-soluble radical polymerization initiator can include persulfate such as potassium persulfate, ammonium persulfate, or the like; azobisaminodipropane acetate; azobiscyanovaleric acid and salts thereof; and hydrogen peroxide.

### Preferred Weight Average Molecular Weight of Amorphous Resin

A weight average molecular weight (Mw) of the amorphous resin is preferably within a range of 5,000 to 150,000, more preferably within a range of 10,000 to 70,000, still more preferably within a range of 15,000 to 60,000, still more preferably within a range of 20,000 to 40,000, and still more preferably within a range of 25,000 to 35,000, from the viewpoint of easy control of plasticity thereof.

### Crystalline Resin

The crystalline resin according to the present invention refers to a resin having an apparent endothermic peak in DSC of the crystalline resin or the toner particle without a stepwise endothermic change. Specifically, the apparent endothermic peak refers to a peak at which a half-value width of an endothermic peak is within 15° C. when measurement by DSC is performed at a heating rate of 10° C./min. A crystalline polyester resin refers to a polyester resin among such crystalline resins.

In an embodiment of the present invention, it is preferable that the binder resin contains at least a crystalline polyester resin. In addition, in an embodiment of the present invention, a crystalline resin other than the crystalline polyester resin can also be used. Such a crystalline resin is not particularly limited, and a known crystalline resin can be used. One or plural kinds of crystalline resins may be used.

### Melting Point of Crystalline Polyester Resin

A melting point (Tm) of the crystalline polyester resin is preferably within a range of 50 to 90° C., and more preferably within a range of 60 to 80° C., from the viewpoint of obtaining sufficient low-temperature fixability and high-temperature preservability.

### Measurement Method of Melting Point

A melting point of the binder resin can be measured by DSC. Specifically, 5 mg of a sample is sealed in an aluminum pan (KITNO.B0143013) and is set in a sample holder of a thermal analyzer Diamond DSC (manufactured by PerkinElmer Co., Ltd.), and then the temperature is changed in order of heating, cooling, and heating. During the first and second heating, the temperature is raised from 0° C. to 100° C. at a heating rate of 10° C./min and then the temperature is maintained at 100° C. for 1 minute. During the cooling, the temperature is lowered from 100° C. to 0° C. at a cooling rate of 10° C./min, and then the temperature is maintained at 0° C. for 1 minute. A temperature of a peak top of an endothermic peak in an endothermic curve obtained during the second heating is measured as a melting point (Tm).

### Preferred Weight Average Molecular Weight and Number Average Molecular Weight of Crystalline Polyester Resin

In addition, it is preferable that a weight average molecular weight (Mw) of the crystalline polyester resin is within a range of 5,000 to 50,000, and a number average molecular weight (Mn) of the crystalline polyester resin is within a range of 2,000 to 10,000, from the viewpoint of exhibiting low-temperature fixability and stable glossiness of the final image. In an embodiment of the present invention, the weight average molecular weight (Mw) of the crystalline polyester resin is more preferably within a range of 7,000 to 40,000, still more preferably within a range of 9,000 to 30,000, and still more preferably within a range of 10,000 to 20,000. In an embodiment of the present invention, the number average molecular weight (Mn) of the crystalline polyester resin is more preferably within a range of 3,000 to 9,000, the number average molecular weight (Mn) of the crystalline polyester resin is still more preferably within a range of 4,000 to 8,000, and the number average molecular weight (Mn) of the crystalline polyester resin is still more preferably within a range of 5,000 to 7,000.

### Measurement Method of Weight Average Molecular Weight and Number Average Molecular Weight

The weight average molecular weight (Mw) and the number average molecular weight (Mn) can be calculated from a molecular weight distribution measured by gel permeation chromatography (GPC) as described below. A sample is added to tetrahydrofuran (THF) so that a concentration becomes 1 mg/mL, a dispersion treatment is performed at room temperature for 5 minutes with an ultrasonic disperser, and then a treatment is performed with a membrane filter having a pore size of 0.2 μm, thereby preparing a sample solution. THF is allowed to flow as a carrier solvent at a flow rate of 0.2 mL/min while maintaining a column temperature of 40° C. with a GPC apparatus HLC-8120 GPC (manufactured by TOSOH CORPORATION) and a column “TSKguardcolumn+TSKgelSuperHZM-M3 series” (manufactured by TOSOH CORPORATION). 10 μL of the prepared sample solution is injected into the GPC apparatus together with the carrier solvent, and the sample is detected with a refractive index detector (RI detector). The molecular weight distribution of the sample is calculated by using a calibration curve measured by using 10 points of monodispersed polystyrene standard particles.

### Content of Crystalline Resin in Toner Base Particle

It is preferable that a content of the crystalline resin in the toner base particle is within a range of 5 to 20% by mass from the viewpoint of achieving both excellent low-temperature fixability and transferability under a high-temperature and high-humidity environment. When the content is 5% by mass or more, the low-temperature fixability of the formed toner image is sufficient. In addition, when the content is 20% by mass or less, the transferability is sufficient.

### Configuration of Crystalline Polyester Resin

The crystalline polyester resin may be obtained by a polycondensation reaction of divalent or higher carboxylic acid (polycarboxylic acid) and dihydric or higher alcohol (polyhydric alcohol).

### Dicarboxylic Acid

Examples of the polycarboxylic acid can include a dicarboxylic acid. One or more kinds of the dicarboxylic acids may be used. The dicarboxylic acid is preferably an aliphatic dicarboxylic acid, and may further include an aromatic dicarboxylic acid. The aliphatic dicarboxylic acid is preferably a linear type from the viewpoint of enhancing crystallinity of the crystalline polyester resin.

### Aliphatic Dicarboxylic Acid

Examples of the aliphatic dicarboxylic acid can include oxalic acid, malonic acid, succinic acid, glutaric acid, adipic acid, pimelic acid, suberic acid, azelaic acid, sebacic acid, 1,9-nonan dicarboxylic acid, 1,10-decane dicarboxylic acid, 1,11-undecane dicarboxylic acid, 1,12-dodecane dicarboxylic acid (dodecanedioic acid), 1,13-tridecane dicarboxylic acid, 1,14-tetradecane dicarboxylic acid, 1,16-hexadecane dicarboxylic acid, 1,18-octadecane dicarboxylic acid, and lower alkyl esters thereof and anhydrides thereof. Among them, an aliphatic dicarboxylic acid having 6 to 16 carbon atoms is preferable, and an aliphatic dicarboxylic acid having 10 to 14 carbon atoms is more preferable, from the viewpoint of efficiently achieving the predetermined effects of the present invention.

### Aromatic Dicarboxylic Acid

Examples of the aromatic dicarboxylic acid can include terephthalic acid, isophthalic acid, orthophthalic acid, t-butyl isophthalic acid, 2,6-naphthalene dicarboxylic acid, and 4,4′-biphenyl dicarboxylic acid. Among them, terephthalic acid, isophthalic acid, or t-butyl isophthalic acid is preferable from the viewpoint of easy availability and easy emulsification.

### Preferred Content of Dicarboxy in Crystalline Polyester Resin

A content of a constituent unit derived from the aliphatic dicarboxylic acid with respect to a constituent unit derived from the dicarboxylic acid in the crystalline polyester resin is preferably 50 mol % or more, more preferably 70 mol % or more, still more preferably 80 mol % or more, and particularly preferably 100 mol %, from the viewpoint of securing sufficient crystallinity of the crystalline polyester resin.

### Diol

Examples of components of the polyhydric alcohol can include a diol. One or more kinds of the diols may be used. The diol is preferably an aliphatic diol, and may further include a diol other than the aliphatic diol. The aliphatic diol is preferably a linear type from the viewpoint of enhancing crystallinity of the crystalline polyester resin.

### Aliphatic Diol

Examples of the aliphatic diol can include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among them, an aliphatic diol having 2 to 12 carbon atoms is preferable, and an aliphatic diol having 4 to 6 carbon atoms is more preferable, from the viewpoint of easily achieving both low-temperature fixability and transferability.

### Other Diols

Examples of a diol other than aliphatic diol can include a diol having a double bond and a diol having a sulfonic acid group. Specific examples of the diol having a double bond can include 2-butene-1,4-diol, 3-hexene-1,6-diol, and 4-octene-1,8-diol.

### Preferred Content of Aliphatic Diol in Crystalline Polyester Resin

A content of a constituent unit derived from the aliphatic diol with respect to a constituent unit derived from the diol in the crystalline polyester resin is preferably 50 mol % or more, more preferably 70 mol % or more, still more preferably 80 mol % or more, and particularly preferably 100 mol %, from the viewpoint of enhancing low-temperature fixability of the toner and glossiness of an image finally formed.

### Preferred Ratio of Diol to Dicarboxylic Acid

In a ratio of the diol to the dicarboxylic acid in the monomer of the crystalline polyester resin, an equivalent ratio [OH]/[COOH] of the hydroxy group [OH] of the diol to the carboxy group [COOH] of the carboxylic acid is preferably within a range of 2.0/1.0 to 1.0/2.0, more preferably within a range of 1.5/1.0 to 1.0/1.5, and particularly preferably within a range of 1.3/1.0 to 1.0/1.3.

### Synthesis of Crystalline Polyester Resin

The crystalline polyester resin can be synthesized by polycondensation (esterification) of the polycarboxylic acid and the polyhydric alcohol by using a known esterification catalyst.

### Catalyst Usable in Synthesis of Crystalline Polyester Resin

One or more kinds of catalysts usable in synthesis of the crystalline polyester resin may be used. Examples thereof can include an alkali metal compound such as sodium, lithium, or the like; a compound containing a Group II element such as magnesium, calcium, or the like; a metal compound such as aluminum, zinc, manganese, antimony, titanium, tin, zirconium, germanium, or the like; a phosphorous acid compound; a phosphoric acid compound; and an amine compound.

Specifically, examples of a tin compound can include dibutyltin oxide, tin octylate, tin dioctylate, and salts thereof. Examples of a titanium compound can include titanium alkoxide such as tetra-n-butyl titanate, tetraisopropyl titanate, tetramethyl titanate, tetrastearyl titanate, or the like; titanium acylate such as polyhydroxy titanium stearate or the like; and titanium chelate such as titanium tetraacetyl acetonate, titanium lactate, titanium triethanolaminate, or the like. Examples of a germanium compound can include germanium dioxide. Examples of an aluminum compound can include oxide such as polyaluminum hydroxide or the like, aluminum alkoxide, and tributyl aluminate.

### Preferred Polymerization Temperature of Crystalline Polyester Resin

A polymerization temperature of the crystalline polyester resin is preferably within a range of 150 to 250° C. In addition, a polymerization time is preferably within a range of 0.5 to 10 hours. An inside pressure of a reaction system may be reduced during polymerization, if necessary.

### Hybrid Crystalline Polyester Resin

The crystalline polyester resin may contain a hybrid crystalline polyester resin (hereinafter, simply referred to as a “hybrid resin”). By containing the hybrid crystalline polyester resin, affinity with the amorphous resin simultaneously used is enhanced, such that low-temperature fixability of the toner is improved. In addition, since dispersibility of the crystalline resin in the toner is improved, bleeding out can be suppressed.

One or more kinds of the hybrid resins may be used. In addition, the hybrid resin may be replaced with a total amount of the crystalline polyester resin, may be partially replaced with the crystalline polyester resin, or may be simultaneously used with the crystalline polyester resin.

The hybrid resin is a resin obtained by chemically bonding a crystalline polyester polymerization segment to an amorphous polymerization segment. The crystalline polyester polymerization segment refers to a portion derived from the crystalline polyester resin. That is, the crystalline polyester polymerization segment refers to a molecular chain having the same chemical structure as that of a molecular chain constituting the crystalline polyester resin described above. In addition, the amorphous polymerization segment refers to a portion derived from the amorphous resin. That is, the amorphous polymerization segment refers to a molecular chain having the same chemical structure as that of a molecular chain constituting the amorphous resin described above.

### Preferred Weight Average Molecular Weight (Mw) of Hybrid Resin

A preferred weight average molecular weight (Mw) of the hybrid resin is preferably within a range of 5,000 to 100,000, more preferably within a range of 7,000 to 50,000, and particularly preferably within a range of 8,000 to 20,000, from the viewpoint of surely achieving of both sufficient low-temperature fixability and excellent long-term storage stability. When Mw of the hybrid resin is 100,000 or less, the sufficient low-temperature fixability can be obtained. On the other hand, when Mw of the hybrid resin is 5,000 or more, excessive compatibilization of the hybrid resin with the amorphous resin during toner storage can be suppressed, and the image defects caused by fusion of the toners can thus be effectively suppressed.

### Crystalline Polyester Polymerization Segment

The crystalline polyester polymerization segment may be, for example, a resin having a structure formed by copolymerizing other components with a main chain formed of a crystalline polyester polymerization segment, and may be a resin having a structure formed by copolymerizing a crystalline polyester polymerization segment with a main chain formed of other components. The crystalline polyester polymerization segment can be synthesized in the same manner as synthesis of the crystalline polyester resin described above with the polycarboxylic acid and the polyhydric alcohol described above.

### Content of Crystalline Polyester Polymerization Segment in Hybrid Resin

A content of the crystalline polyester polymerization segment in the hybrid resin is preferably within a range of 80 to 98% by mass, more preferably within a range of 90 to 95% by mass, and still more preferably within a range of 91 to 93% by mass, from the viewpoint of imparting sufficient crystallinity to the hybrid resin. A constituent component and a content of each polymerization segment in the hybrid resin (or in the toner) can be determined by using a known analysis method such as a nuclear magnetic resonance (NMR) method or methylation reaction pyrolysis gas chromatography/mass spectrometry (Py-GC/MS).

### Aspect of Preferred Crystalline Polyester Polymerization Segment

It is preferable that the crystalline polyester polymerization segment further includes a monomer having an unsaturated bond in the monomer from the viewpoint of introducing a chemical bonding site with the amorphous polymerization segment into the segment. The monomer having an unsaturated bond is, for example, a polyhydric alcohol having a double bond, and examples thereof can include a polycarboxylic acid having a double bond such as methylene succinic acid, fumaric acid, maleic acid, 3-hexenedioic acid, 3-octenedioic acid, or the like, 2-butene-1,4-diol, 3-hexene-1,6-diol, and 4-octene-1,8-diol. A content of a constituent unit derived from the monomer having an unsaturated bond in the crystalline polyester polymerization segment is preferably within a range of 0.5 to 20% by mass.

The hybrid resin may be a block copolymer or a graft copolymer. However, the hybrid resin is preferably a graft copolymer from the viewpoint of easily controlling an orientation of the crystalline polyester polymerization segments and imparting sufficient crystallinity to the hybrid resin. It is more preferable that the crystalline polyester polymerization segment is grafted to an amorphous polymerization segment as a main chain. That is, it is preferable that the hybrid resin is a graft copolymer having the amorphous polymerization segment as a main chain and having the crystalline polyester polymerization segment as a side chain.

### Introduction of Functional Group

A functional group such as a sulfonic acid group, a carboxy group, a urethane group, or the like may be further introduced into the hybrid resin. The functional group may be introduced into the crystalline polyester polymerization segment, or into the amorphous polymerization segment.

### Amorphous Polymerization Segment

The amorphous polymerization segment enhances affinity between the amorphous resin and the hybrid resin that constitute the binder resin. By doing so, the hybrid resin is easily incorporated into the amorphous resin, and charging uniformity of the toner is thus further improved. A constituent component and a content of the amorphous polymerization segment in the hybrid resin (or in the toner) can be determined by using a known analysis method such as an NMR method or methylation reaction Py-GC/MS.

In addition, similarly to the amorphous resin according to the present invention, a glass transition temperature (Tg₁) of the amorphous polymerization segment in a first heating process of DSC is preferably within a range of 30 to 80° C., and more preferably within a range of 40 to 65° C. The glass transition temperature (Tg₁) can be measured by a known method (for example, DSC).

### Aspect of Preferred Amorphous Polymerization Segment

It is preferable that the amorphous polymerization segment is formed of a resin of the same kind as the amorphous resin contained in the binder resin from the viewpoint of enhancing affinity with the binder resin and enhancing charging uniformity of the toner. By adopting such a form, the affinity of the hybrid resin with the amorphous resin is further enhanced The term “the same kind of resins” indicates resins having a common characteristic chemical bond in a repeating unit.

The “characteristic chemical bond” is defined according to “polymer classification” described in a material database provided by National Institute for Material Science (NIMS)

(http://polymer.nims.go.jp/PoLyInfo/guide/jp/term_polymer.html). That is, the “characteristic chemical bond” refers to chemical bonds that constitute polymers classified by 22 kinds of polymers including polyacryl, polyimide, polyacid anhydride, polycarbonate, polydiene, polyester, polyhaloolefin, polyimide, polyimine, polyketone, polyolefin, polyether, polyphenylene, polyphosphazene, polysiloxane, polystyrene, polysulfide, polysulfone, polyurethane, polyurea, polyvinyl, and another polymer.

In addition, in a case where the resin is a copolymer, the term “the same kind of resins” indicates resins having a common chemical bond in a case where a monomer having the chemical bond serves as a constituent unit in a chemical structure of a plurality of monomers constituting the copolymer. Accordingly, even in a case where resins themselves exhibit different properties with each other or have different molar component ratios of the monomers constituting the copolymer, the resins having a common characteristic chemical bond are considered as the same kind of resins.

For example, a resin (or a polymerization segment) formed by styrene, butyl acrylate, and acrylic acid, and a resin (or a polymerization segment) formed by styrene, butyl acrylate, and methacrylic acid have at least a chemical bond constituting polyacryl. Therefore, these resins are the same kind of resins. By way of another example, a resin (or a polymerization segment) formed by styrene, butyl acrylate, and acrylic acid, and a resin (or a polymerization segment) formed by styrene, butyl acrylate, acrylic acid, terephthalic acid, and fumaric acid have at least a chemical bond constituting polyacryl as a mutually common chemical bond. Therefore, these resins are the same kind of resins.

Examples of the amorphous polymerization segment can include a vinyl polymerization segment, a urethane polymerization segment, and a urea polymerization segment. Among them, a vinyl polymerization segment is preferable from the viewpoint of easy control of thermoplasticity. The vinyl polymerization segment may be synthesized in the same manner as that of the vinyl resin according to the present invention.

### Preferred Content of Constituent Unit Derived from Styrene Monomer

A content of a constituent unit derived from the styrene monomer in the amorphous polymerization segment is preferably within a range of 40 to 90% by mass from the viewpoint of easily controlling plasticity of the hybrid resin. In addition, from the same viewpoint, a content of a constituent unit derived from the (meth)acrylic acid ester monomer in the amorphous polymerization segment is preferably within a range of 10 to 60% by mass.

### Preferred Content of Amphoteric Compound

Further, it is preferable that the amorphous polymerization segment further contains the amphoteric compound described above in a monomer from the viewpoint of introducing a chemical bond site with the crystalline polyester polymerization segment into the amorphous polymerization segment. A content of a constituent unit derived from the amphoteric compound in the amorphous polymerization segment is preferably within a range of 0.5 to 20% by mass.

### Preferred Content of Amorphous Polymerization Segment in Hybrid Resin

A content of the amorphous polymerization segment in the hybrid resin is preferably within a range of 3 to 15% by mass, more preferably within a range of 5 to 10% by mass, and still more preferably within a range of 7 to 9% by mass, from the viewpoint of imparting sufficient crystallinity to the hybrid resin.

### Production Method of Hybrid Resin

The hybrid resin can be produced, for example, by the following first to third production methods.

### First Production Method

The first production method is a method of producing a hybrid resin by performing a polymerization reaction for synthesizing a crystalline polyester polymerization segment in the presence of an amorphous polymerization segment synthesized in advance.

In the first method, first, the amorphous polymerization segment is synthesized by an addition reaction of monomers (preferably, vinyl monomer such as a styrene monomer or a (meth)acrylic acid ester monomer) constituting the amorphous polymerization segment described above. Subsequently, the crystalline polyester polymerization segment is synthesized by a polymerization reaction of a polycarboxylic acid with a polyhydric alcohol in the presence of the amorphous polymerization segment. In this case, the polycarboxylic acid and the polyhydric alcohol are subjected to a condensation reaction, and the polycarboxylic acid or the polyhydric alcohol is subjected to an addition reaction to the amorphous polymerization segment, thereby synthesizing a hybrid resin.

In the first production method, it is preferable that a site at which the crystalline polyester polymerization segment and the amorphous polymerization segment can react with each other is incorporated into the crystalline polyester polymerization segment or the amorphous polymerization segment. Specifically, the amphoteric compound described above may be used in addition to the monomers constituting the amorphous polymerization segment at the time of synthesizing the amorphous polymerization segment. The amphoteric compound reacts with a carboxy group or a hydroxy group in the crystalline polyester polymerization segment, such that the crystalline polyester polymerization segment is chemically and quantitatively bound to the amorphous polymerization segment. In addition, the compound having an unsaturated bond described above may also be further contained in the monomer at the time of synthesizing the crystalline polyester polymerization segment.

A hybrid resin having a structure (graft structure) in which the crystalline polyester polymerization segment is molecularly bound to the amorphous polymerization segment can be synthesized by the first production method.

### Second Production Method

The second production method is a method in which a crystalline polyester polymerization segment and an amorphous polymerization segment are respectively formed, and then bound to each other to produce a hybrid resin.

In the second production method, first, the crystalline polyester polymerization segment is synthesized by a condensation reaction of a polycarboxylic acid with a polyhydric alcohol. In addition, apart from a reaction system for synthesizing a crystalline polyester polymerization segment, an amorphous polymerization segment is synthesized by an addition polymerization of monomers constituting the amorphous polymerization segment described above. In this case, it is preferable that a site at which the crystalline polyester polymerization segment and the amorphous polymerization segment can react with each other is incorporated into one or both of the crystalline polyester polymerization segment and the amorphous polymerization segment as described above.

Subsequently, a hybrid resin having a structure in which the crystalline polyester polymerization segment is molecularly bound to the amorphous polymerization segment can be synthesized by a reaction of the synthesized crystalline polyester polymerization segment and amorphous polymerization segment.

In addition, in a case where the site at which the crystalline polyester polymerization segment and the amorphous polymerization segment can react with each other is not incorporated into any one of the crystalline polyester polymerization segment and the amorphous polymerization segment, in a system in which the crystalline polyester polymerization segment and the amorphous polymerization segment coexist, a method of adding a compound having a site that can be bound to either the crystalline polyester polymerization segment or the amorphous polymerization segment may be adopted. By doing so, it is possible to synthesize a hybrid resin having a structure in which the crystalline polyester polymerization segment is molecularly bound to the amorphous polymerization segment via the compound.

### Third Production Method

The third production method is a method of producing a hybrid resin by performing a polymerization reaction for synthesizing an amorphous polymerization segment in the presence of a crystalline polyester polymerization segment.

In the third production method, first, the crystalline polyester polymerization segment is synthesized by performing polymerization through a condensation reaction of a polycarboxylic acid with a polyhydric alcohol. Subsequently, an amorphous polymerization segment is synthesized by a polymerization reaction of monomers constituting the amorphous polymerization segment in the presence of the crystalline polyester polymerization segment. In this case, similarly to the first production method, it is preferable that a site at which the crystalline polyester polymerization segment and the amorphous polymerization segment can react with each other is incorporated into the crystalline polyester polymerization segment or the amorphous polymerization segment.

A hybrid resin having a structure (graft structure) in which the amorphous polymerization segment is molecularly bound to the crystalline polyester polymerization segment can be synthesized by the production methods described above.

Among the first to third production methods, the first production method enables to easily synthesize a hybrid resin having a structure in which the crystalline polyester resin chain is grafted to the amorphous resin chain, and can simplify a production process, which is preferable. In the first production method, since the amorphous polymerization segment is formed in advance, and the crystalline polyester polymerization segment is bounded, an orientation of the crystalline polyester polymerization segments is likely to be uniform.

### Release Agent

The electrostatic latent image developing toner of the present invention contains a release agent. The release agent of the present invention contains a hydrocarbon wax having a branching degree of 3 to 52%.

In the electrostatic latent image developing toner of the present invention, the hydrocarbon wax having a branching degree of 3 to 52% and the crystalline resin are simultaneously used, such that the release agent and the crystalline resin interact with each other to promote crystallization of the release agent and the crystalline resin, and thus, the top temperature of the exothermic peak during cooling of the toner may be set to 60 to 85° C. Then, adhesion of the wax to a member in contact with a toner image such as a paper discharge roller or the like can be suppressed because even in a case where a temperature near the paper discharge roller is about 60° C. when the toner image is discharged while cooling the toner image after fixing, the wax is crystallized at the temperature. In addition, the branching degree of the hydrocarbon wax is 3 to 52%, such that an image with no quality defects such as gloss unevenness and gloss memory can be obtained. When the branching degree of the hydrocarbon wax is less than 3%, a crystal size is increased due to a cooling rate difference between an image portion in contact with a conveying member or the like and an image portion in no contact with the conveying member or the like, and thus, the image quality defect called gloss unevenness occurs. When the branching degree of the hydrocarbon wax exceeds 52%, crystallinity is reduced, and adhesion of the release agent to a fixing roller at the time of fixing is increased. Therefore, the adhered release agent is transferred to the next image, and thus, the image quality defect called gloss memory in which a gloss difference between the previous and next images occurs.

### Branching Degree of Hydrocarbon Wax

The branching degree of the hydrocarbon wax is measured as follows.

A xylene solution having a sample concentration of 1% was heated and analyzed with a GC/FID chromatogram (high temperature analysis) (apparatus name: Shimadzu GC-2010 Plus) under the following conditions.

An area rate (%) of a branched hydrocarbon in an area of the obtained chromatogram was calculated as a branching degree.

### Analysis Condition

Column: UA-SIMDIS(HT) 5 m*0.53 mmi.d.*0.1 um

Injection port: 350° C.

Detection: FID 430° C.

When two or more kinds of waxes are contained, the branching degree of the present invention is measured in a mixed state of the waxes.

### Hydrocarbon Wax Having Branching Degree of 3 to 52%

According to an embodiment of the present invention, the branching degree of the hydrocarbon wax is preferably 5 to 40%. According to an embodiment of the present invention, the branching degree of the hydrocarbon wax is more preferably 6 to 30%, still more preferably 7 to 28%, and still more preferably 10 to 25%. When the branching degree is within a preferred range, an image with no image defects such as gloss unevenness, gloss memory, and the like can be efficiently obtained. In addition, the excellent results of an adhesion test of the release agent can be obtained.

According to an embodiment of the present invention, a melting point of the hydrocarbon wax having the branching degree of 3 to 52% is preferably 60 to 90° C., more preferably 65 to 85° C., and still more preferably 70 to 83° C. According to such an embodiment, there is a technical effect that it is easy to adjust the top temperature of the exothermic peak during cooling when the hydrocarbon wax is contained in the toner to 60 to 85° C. In addition, the desired effect of the present invention can be efficiently achieved. A melting point of the release agent can be measured by the same method as in the case of the melting point of the binder resin.

According to an embodiment of the present invention, a weight average molecular weight of the hydrocarbon wax having the branching degree of 3 to 52% is preferably 300 to 800, more preferably 400 to 800, and still more preferably 400 to 700. According to such an embodiment, there is a technical effect that it is easy to adjust the top temperature of the exothermic peak during cooling when the hydrocarbon wax is contained in the toner to 60 to 85° C.

The kind of the hydrocarbon wax is not particularly limited, as long as a branching degree thereof is 3 to 52%, but examples of the hydrocarbon wax can include a polyolefin wax such as a polyethylene wax, a polypropylene wax, or the like; a branched-chain hydrocarbon wax such as a microcrystalline wax or the like; and a long-chain hydrocarbon such as a paraffin wax (for example, Fischer-Tropsch wax), a Sasol wax, or the like.

According to an embodiment of the present invention, a microcrystalline wax, a paraffin wax, or the like is preferable.

### Microcrystalline Wax

The microcrystalline wax refers to a wax which differs from a paraffin wax in which a linear chain hydrocarbon (normal paraffin) is used as a main component and includes a large amount of a branched-chain hydrocarbon (isoparaffin) or a ring hydrocarbon (cycloparaffin) in addition to a linear hydrocarbon, among petroleum waxes. In general, since the microcrystalline wax contains a large amount of a low crystalline isoparaffin or cycloparaffin, a crystal thereof is small and a molecular weight thereof is large as compared with the paraffin wax. It is preferable that the number of carbon atoms of the microcrystalline wax is within a range of 30 to 60, a weight average molecular weight of the microcrystalline wax is within a range of 500 to 800, and a melting point of the microcrystalline wax is within a range of 60 to 90° C. In addition, it is more preferable that the weight average molecular weight of the microcrystalline wax is within a range of 600 to 800, and the melting point of the microcrystalline wax is within a range of 60 to 85° C. In addition, in particular, the microcrystalline wax has a low molecular weight, and a number average molecular weight of the microcrystalline wax is preferably within a range of 300 to 1,000, and more preferably within a range of 400 to 800. In addition, a ratio (Mw/Mn) of the weight average molecular weight to the number average molecular weight is preferably within a range of 1.01 to 1.20.

As the microcrystalline wax, a microcrystalline wax having a branching degree of 3 to 52% may be synthesized by using a known technique, or a commercially available product having a branching degree of 3 to 52% may be prepared.

For example, HNP-0190, Hi-Mic-1090, or the like manufactured by NIPPON SEIRO CO., LTD. is known as the microcrystalline wax. However, since these microcrystalline waxes each have a high branching degree, the branching degrees of all these microcrystalline waxes are not within a range of 3 to 52%. Accordingly, for example, when HNP-0190 is used, it is required to be combined with another hydrocarbon wax in order to obtain a hydrocarbon wax having a branching degree of 3 to 52%. Examples of the other hydrocarbon wax can include FNP0090 manufactured by NIPPON SEIRO CO., LTD., C80 manufactured by Sasol Ltd., and the like.

### Paraffin Wax

The paraffin wax is a hydrocarbon compound of which a main component is a linear chain hydrocarbon (normal paraffin). It is preferable that a weight average molecular weight of the paraffin wax is within a range of 400 to 1,000, and a melting point of the paraffin wax is within a range of 60 to 90° C. In addition, it is more preferable that the weight average molecular weight of the paraffin wax is within a range of 500 to 800, and the melting point of the paraffin wax is within a range of 65 to 80° C. As the paraffin wax, a paraffin wax having a branching degree of 3 to 52% may be synthesized by using a known technique, or a commercially available product having a branching degree of 3 to 52% may be prepared.

According to an embodiment of the present invention, the release agent contains a wax other than the hydrocarbon wax. By containing a wax other than the hydrocarbon wax, the amount of exudation or a crystallization rate of the wax can be adjusted within a preferred range. According to an embodiment of the present invention, a content of the wax other than the hydrocarbon wax is 90% by mass or less with respect to a total mass of the release agent. When the content is 90% by mass or less, gloss unevenness can be suppressed. According to an embodiment of the present invention, the content of the wax other than the hydrocarbon wax is preferably 70% by mass or less, more preferably 50% by mass or less, still more preferably 10% by mass or less, and still more preferably less than 5% by mass According to an embodiment of the present invention, a lower limit of the content of the wax other than the hydrocarbon wax is more than 0% by mass, 1% by mass or more, or 2% by mass or more.

According to an embodiment of the present invention, the wax other than the hydrocarbon wax is an ester wax. The ester wax contains at least an ester. According to an embodiment of the present invention, two or more kinds of the hydrocarbon waxes are used in combination so that the hydrocarbon wax has a predetermined branching degree.

Any one of a monoester, a diester, a triester, and a tetraester can be used as the ester. Examples of the ester can include esters of a higher fatty acid and a higher alcohol having a structure represented by any one of the following General Formulas (1) to (3), trimethylolpropane triesters having a structure represented by the following General Formula (4), glycerin esters having a structure represented by the following General Formula (5), pentaerythritol tetraesters having a structure represented by the following General Formula (6), and the like.

R¹—COO—R² General Formula (1)

R¹—COO—(CH₂)ₙ—OCO—R² General Formula (2)

R¹—OCO—(CH₂)ₙ—COO—R² General Formula (3)

In General Formulas (1) to (3), R¹ and R² each independently represent a substituted or unsubstituted hydrocarbon group having 13 to 30 carbon atoms. R¹ and R² may be the same as each other, or may be different from each other. n represents an integer of 1 to 30.

R¹ and R² each represent a hydrocarbon group having 13 to 30 carbon atoms, but each are preferably a hydrocarbon group having 17 to 22 carbon atoms.

n represents an integer of 1 to 30, but preferably represents an integer of 1 to 12.

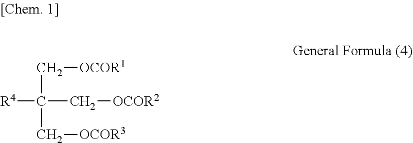

In General Formula (4), R¹ to R⁴ each independently represent a substituted or unsubstituted hydrocarbon group having 13 to 30 carbon atoms. R¹ to R⁴ may be the same as each other, or may be different from each other. R¹ to R⁴ each are preferably a hydrocarbon group having 17 to 22 carbon atoms.

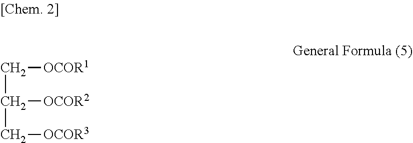

In General Formula (5), R¹ to R³ each independently represent a substituted or unsubstituted hydrocarbon group having 13 to 30 carbon atoms. R¹ to R³ may be the same as each other, or may be different from each other. R¹ to R³ each are preferably a hydrocarbon group having 17 to 22 carbon atoms.

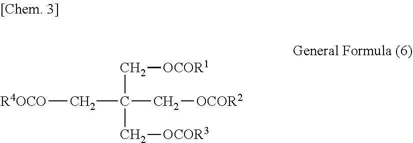

In General Formula (6), R¹ to R⁴ each independently represent a substituted or unsubstituted hydrocarbon group having 13 to 30 carbon atoms. R¹ to R⁴ may be the same as each other, or may be different from each other. R¹ to R⁴ each are preferably a hydrocarbon group having 17 to 22 carbon atoms.

A substituent which may be included in each of R¹ to R⁴ is not particularly limited within a range in which the effects of the present invention are not impaired. Examples of the substituent can include a linear or branched alkyl group, an alkenyl group, an alkynyl group, an aromatic hydrocarbon ring group, an aromatic heterocyclic group, a non-aromatic hydrocarbon ring group, a non-aromatic heterocyclic group, an alkoxy group, a cycloalkoxy group, an acyloxy group, an alkylthio group, a cycloalkylthio group, an arylthio group, an alkoxycarbonyl group, an aryloxycarbonyl group, a sulfamoyl group, an acyl group, an acyloxy group, an amide group, a carbamoyl group, a ureido group, a sulfinyl group, an alkylsulfonyl group, an arylsulfonyl group or a heteroarylsulfonyl group, an amino group, a halogen atom, a fluorinated hydrocarbon group, a cyano group, a nitro group, a hydroxy group, a thiol group, a silyl group, a deuterium atom, and the like.

Specific examples of the monoester having a structure represented by General Formula (1) can include compounds having structures represented by the following Formulas (1-1) to (1-8), respectively.

CH₃—(CH₂)₁₂—COO—(CH₂)₁₃—CH₃ Formula (1-1)

CH₃—(CH₂)₁₄—COO—(CH₂)₁₅—CH₃ Formula (1-2)

CH₃—(CH₂)₁₆—COO—(CH₂)₁₇—CH₃ Formula (1-3)

CH₃—(CH₂)₁₆—COO—(CH₂)₂₁—CH₃ Formula (1-4)

CH₃—(CH₂)₂₀—COO—(CH₂)₁₇—CH₃ Formula (1-5)

CH₃—(CH₂)₂₀—COO—(CH₂)₂₁—CH₃ Formula (1-6)

CH₃—(CH₂)₂₅—COO—(CH₂)₂₅—CH₃ Formula (1-7)

CH₃—(CH₂)₂₈—COO—(CH₂)₂₉—CH₃ Formula (1-7)

Specific examples of the diester having a structure represented by General Formula (2) or (3) can include compounds having structures represented by the following Formulas (2-1) to (2-7) and (3-1) to (3-3), respectively.

CH₃—(CH₂)₂₀—COO—(CH₂)₄—OCO—(CH₂)₂₀—CH₃ Formula (2-1)

CH₃—(CH₂)₁₈—COO—(CH₂)₄—OCO—(CH₂)₁₈—CH₃ Formula (2-2)

CH₃—(CH₂)₂₀—COO—(CH₂)₂—OCO—(CH₂)₂₀—CH₃ Formula (2-3)

CH₃—(CH₂)₂₂—COO—(CH₂)₂—OCO—(CH₂)₂₂—CH₃ Formula (2-4)

CH₃—(CH₂)₁₆—COO—(CH₂)₄—OCO—(CH₂)₁₆—CH₃ Formula (2-5)

CH₃—(CH₂)₂₆—COO—(CH₂)₂—OCO—(CH₂)₂₆—CH₃ Formula (2-6)

CH₃—(CH₂)₂₀—COO—(CH₂)₆—OCO—(CH₂)₂₀—CH₃ Formula (2-7)

CH₃—(CH₂)₂₁—OCO—(CH₂)₆—COO—(CH₂)₂₁—CH₃ Formula (3-1)

CH₃—(CH₂)₂₃—OCO—(CH₂)₆—COO—(CH₂)₂₃—CH₃ Formula (3-2)

CH₃—(CH₂)₁₉—OCO—(CH₂)₆—COO—(CH₂)₁₉—CH₃ Formula (3-3)

Specific examples of the triester having a structure represented by General Formula (4) can include compounds having structures represented by the following Formulas (4-1) to (4-6), respectively.

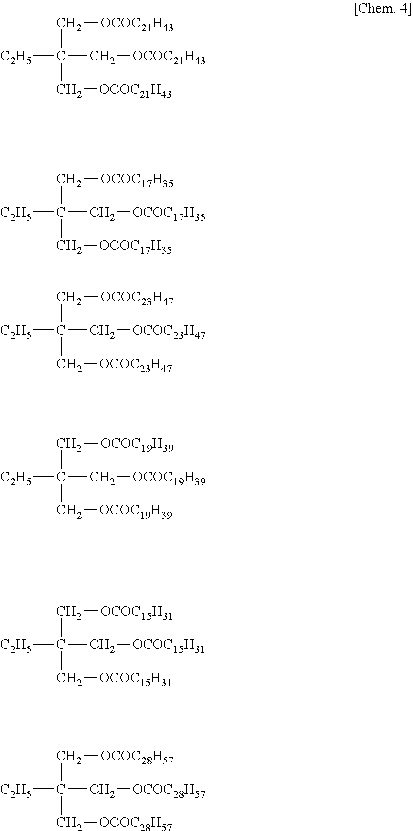

Specific examples of the triester having a structure represented by General Formula (5) can include compounds having structures represented by the following Formulas (5-1) to (5-6), respectively.

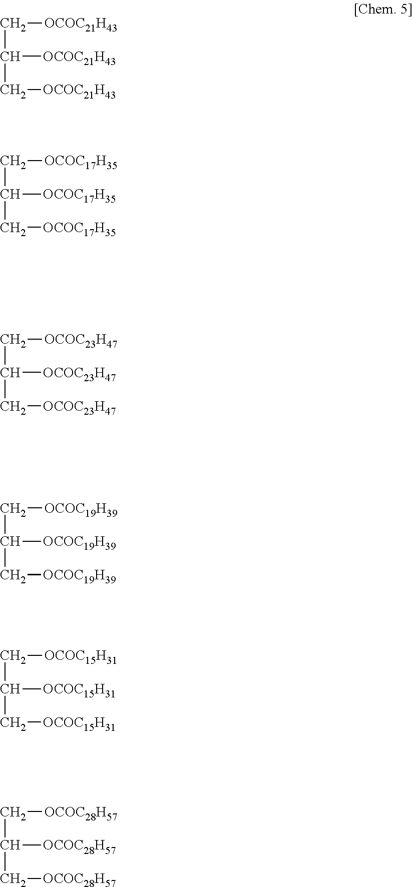

Specific examples of the tetraester having a structure represented by General Formula (6) can include compounds having structures represented by the following Formulas (6-1) to (6-5), respectively.

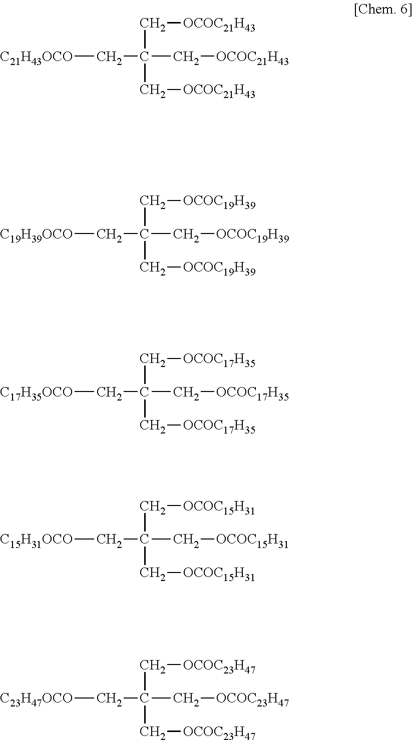

Among them, as the ester, a monoester is preferable.

In addition, an ester wax that can be used in the release agent may have a structure having a plurality of structures of a monoester, a diester, a triester, and a tetraester in one molecule.

In addition, in the release agent, two or more kinds of the esters can be used in combination.

### Preferred Content of Release Agent

In the toner base particle, a content of the release agent is preferably within a range of 3 to 15% by mass, and more preferably within a range of 5 to 12% by mass

### Colorant

A known inorganic or organic colorant can be used as the colorant contained in the toner base particle of the present invention. Various organic or inorganic pigments and dyes, and the like can be used as the colorant, in addition to carbon black, magnetic powder. In particular, a chromatic color pigment is preferably used, and a phthalocyanine pigment is preferably used as the inorganic pigment. An addition amount of the colorant is 1 to 30% by mass, and is preferably within a range of 2 to 20% by mass, with respect to the toner particle.

### Measurement of Dispersion Diameter of Colorant

A dispersion diameter of the colorant in the toner particles can be calculated as a number mean value of a horizontal Feret diameter of dispersed particles of the colorant in a cross section of the toner.

A method of creating a cross section of a toner is as follows. The toner is sufficiently dispersed in an acrylic resin which is curable at room temperature to be embedded and cured in the acrylic resin, and then a thin sample is cut out by using a microtome provided with a diamond knife. An image of the cross section of the toner is captured at a magnification of 30,000 and an acceleration voltage of 80 kV with a transmission electron microscope JEM-2000FX (manufactured by JEOL, Ltd.), and the image is photographed by a scanner. Thereafter, a horizontal Feret diameter (FEREH) of the colorant dispersed in a toner binder resin can be measured with an image processing analyzer LUZEXAP (manufactured by Nireco Corporation). The measurement is performed until the number of measured dispersed particles of the colorant takes a normal distribution per toner, and the operation described above is performed for 10 toners. The measured number mean value of the total dispersed particles of the colorant is calculated, and the calculated value is defined as a number mean dispersion diameter of the colorant. However, the number of the dispersed particles of the colorant is set to 100, when the number of the dispersed particles of the colorant is less than 100, the number of toners to be observed is increased. The dispersed particles of the colorant refer to dispersed particles in a state where particles independently exist in the binder resin rather than primary particles.

In an embodiment of the present invention, the dispersion diameter of the colorant that is calculated as the number mean value of the horizontal Feret diameter of the dispersed particles of the colorant is 50 nm or more, 60 nm or more, 70 nm or more , 80 nm or more, 90 nm or more, more than 90 nm, 95 nm or more, 100 nm or more, 200 nm or more, 300 nm or more, 400 nm or more, or more than 400 nm. In an embodiment of the present invention, the dispersion diameter of the colorant that is calculated as the number mean value of the horizontal Feret diameter of the dispersed particles of the colorant is 500 nm or less, 400 nm or less, 300 nm or less, 200 nm or less, 100 nm or less, or less than 100 nm.

In an embodiment of the present invention, a volume-based median diameter d₅₀ of the colorant in the colorant dispersion is 50 nm or more, 60 nm or more, 70 nm or more, 80 nm or more, 90 nm or more, more than 90 nm, 95 nm or more, 100 nm or more. In an embodiment of the present invention, a volume-based median diameter d50 of the colorant in the colorant dispersion is 400 nm or less, 300 nm or less, 200 nm or less, 100 nm or less or less than 100 nm. a volume-based median diameter d₅₀ of the colorant in the colorant dispersion can be measured by a microtrac particle size dispersion measuring apparatus such as “UPA-150” (manufactured by Nikkiso Co., Ltd.) etc.

### Charge Control Agent and External Additive

The toner particle can contain a charge control agent, an external additive, and the like, if necessary.

### Charge Control Agent

As the charge control agent, a known compound such as a nigrosine dye, a metal salt such as naphthenic acid or higher fatty acid, alkoxylated amine, a quaternary ammonium salt, an azo metal complex, metal salicylate, or the like can be used. A toner having excellent chargeability can be obtained by the charge control agent.

In general, a content of the charge control agent can be within a range of 0.1 to 5.0 parts by mass with respect to 100 parts by mass of the binder resin.

### External Additive

The toner particle can be used as a toner as it is, but may be treated with an external additive such as a fluidizing agent, a cleaning aid, or the like, in order to improve fluidity, chargeability, cleaning properties, and the like.

Examples of the external additive can include an inorganic oxide fine particle such as a silica fine particle, an alumina fine particle, a titanium oxide fine particle, or the like; an inorganic stearate compound fine particle such as an aluminum stearate fine particle, a zinc stearate fine particle, or the like; and an inorganic titanate compound fine particle such as strontium titanate, zinc titanate, or the like. These external additives can be used alone, or in combination of two or more kinds thereof.

These inorganic particles are preferably subjected to a gloss treatment with a silane coupling agent, a titanium coupling agent, a higher fatty acid, silicone oil, or the like, from the viewpoint of improving heat-resistant storability and environmental stability.

An addition amount of the external additive (in a case where a plurality of external additives are used, a total addition amount of the external additives) is preferably within a range of 0.05 to 5 parts by mass, and more preferably within a range of 0.1 to 3 parts by mass, with respect to 100 parts by mass of the toner.

### Description of Configuration of Electrostatic Latent Image Developing Toner

### Core-Shell Structure

The toner particle can be used as a toner as it is, but may be a toner particle having a multi-layered structure such as a core-shell structure including the toner particle as a core particle and a shell layer covering the core particle and a surface of the core particle. The shell layer may not entirely cover the surface of the core particle, and the core particle may be partially exposed. A cross section of the core-shell structure can be confirmed, for example, with a known observation unit such as a transmission electron microscope (TEM), a scanning probe microscope (SPM), or the like.

In the case of the core-shell structure, characteristics, such as a glass transition point, a melting point, a hardness, and the like, of the core particle and the shell layer can be different from each other, and a toner particle depending on the purpose can thus be designed. For example, a shell layer can be formed by agglomerating and fusing resins having a relatively high glass transition point (Tg) on a surface of a core particle containing a binder resin, a colorant, a release agent, and the like and having a relatively low glass transition point (Tg). The shell layer preferably contains an amorphous resin (in particular, styrene-acrylic modified polyester resin).

### Particle Diameter of Toner Particle

In a particle diameter of the toner particle, a volume-based median diameter (d₅₀) is preferably within a range of 3 to 10 μm, and more preferably within a range of 5 to 8 μm. When the volume-based median diameter is within the above range, high reproducibility can be obtained even in a very fine dot image with a level of 1,200 dpi. The particle diameter of the toner particle can be controlled by a concentration of an aggregation agent to be used at the time of production of the toner particle, an addition amount of an organic solvent, a fusing time, a composition of the binder resin, and the like. The volume-based median diameter (d₅₀) of the toner particle can be measured with a measuring apparatus in which a computer system installed with data processing software “Software V3.51” is connected to a Multisizer 3 (manufactured by Beckman Coulter, Inc.). Specifically, a measuring sample (toner) is added to and mixed with a surfactant solution (for dispersing the toner particles, for example, a surfactant solution prepared by eluting a neutral detergent containing a surfactant component with purified water by 10 times), and then ultrasonic dispersion is performed, thereby preparing a toner particle dispersion. The toner particle dispersion is injected into a beaker in which ISOTON II (manufactured by Beckman Coulter, Inc.) is added in a sample stand with a pipette until a concentration displayed by the measuring apparatus reaches 8%. Here, a reproducible measured value can be obtained at such a concentration. Then, using the measuring apparatus, the number of counts of measured particles is set to 25,000, an aperture diameter is set to 100 μm. Then, a range of 2 to 60 μm that is a measuring range is divided into 256 and frequency values thereof are calculated. And then, a particle diameter corresponding to 50% of a volume cumulative fraction from a large diameter side is obtained as a volume-based median diameter (d₅₀).

### Average Circularity of Toner Particles

It is preferable that an average circularity of the toner particles is preferably within a range of 0.930 to 1.000, and more preferably within a range of 0.940 to 0.995, from the viewpoint of enhancing stability of chargeability and low-temperature fixability. When the average circularity is within the above range, each of the toner particle is less likely to be crushed. Therefore, contamination of a frictional charging member is suppressed, and thus, chargeability of the toner can be stabilized, and quality of images to be formed can be improved. The average circularity of the toner particles can be measured with an FPIA-2100 (manufactured by Sysmex Corporation).

Specifically, the measuring sample (toner) is mixed with an aqueous solution containing a surfactant, and is uniformly dispersed by performing an ultrasonic dispersion treatment for 1 minute. Thereafter, images of the particles are captured at an appropriate concentration corresponding to a high-power field (HPF) detect number of 3,000 to 10,000 under a measurement condition of an HPF mode with the FPIA-2100 (manufactured by Sysmex Corporation). When the HPF detect number is within the above range, a reproducible measured value can be obtained. From the captured particle images, a circularity of each toner particle is calculated according to the following Equation (I), and the sum of the circularities of the respective particles are calculated and divided by the total number of the toner particles, thereby obtaining an average circularity.

Circularity=(perimeter of circle having the same projection area as that of particle image)/(perimeter of particle projection image) Equation (I):

### Developer

The electrostatic latent image developing toner of the present invention can be used as a magnetic or non-magnetic single-component developer, but may be used as a double-component developer by being mixed with a carrier. In a case where the toner is used as a double-component developer, as a carrier, a magnetic particle consisting of materials known in the related art such as metals such as iron, ferrite, magnetite, and the like, and alloys of these metals with aluminum, lead, or the like can be used, and, in particular, a ferrite particle is preferable.

In addition, a coated carrier obtained by coating a surface of the magnetic particle with a coating agent such as a resin or the like, a dispersed carrier in which magnetic fine powder is dispersed in a binder resin, may be used as the carrier.

A volume-based median diameter (d₅₀) of the carrier is preferably within a range of 20 to 100 μm, and more preferably within a range of 25 to 80 μm.

The volume-based median diameter (d₅₀) of the carrier can be measured with a laser diffraction type particle size distribution measuring apparatus “HELOS” (manufactured by SYMPATEC GmbH) provided with a wet type disperser.

### Production Method of Toner

A production method of a toner according to the present invention may include steps for agglomerating and fusing of a colorant dispersion and a binder resin dispersion in an aqueous medium, and a known method can be adopted. For example, an emulsion polymerization aggregation method or an emulsion aggregation method can be adequately adopted.

The emulsion polymerization aggregation method preferably used in the production method of the toner according to the present invention is a method of producing a toner particle, the method including: mixing a dispersion of a fine particle of a binder resin (hereinafter, referred to as a “binder resin fine particle”) produced by an emulsion polymerization method with a dispersion of a fine particle of a colorant (hereinafter, referred to as a “colorant fine particle”) and a dispersion of a release agent such as a wax; allowing aggregation to proceed until a toner particle has a predetermined particle diameter; and controlling a shape of the toner particle by fusing the binder resin fine particles. In this case, it is preferable that the release agent is mixed with the binder resin in advance without preparation of the dispersion of the release agent.

In addition, the emulsion aggregation method preferably used as the production method of the toner according to the present invention is a method of producing a toner particle, the method including: adding dropwise a binder resin solution dissolved in a solvent to a poor solvent so as to obtain a resin particle dispersion; mixing the resin particle dispersion with a colorant dispersion and a release agent dispersion such as a wax, allowing aggregation to proceed until a toner particle has a predetermined particle diameter; and controlling a shape of the toner particle by fusing the binder resin fine particles. In this case, it is also preferable that the release agent is mixed with the binder resin in advance without preparation of the dispersion of the release agent.

Both production methods can be applied to the toner of the present invention.

An example of the production method of the toner of present invention by using an emulsion polymerization aggregation method is described below.

(1) Preparing of a dispersion in which colorant fine particles are dispersed in an aqueous medium

(2) Preparing of a dispersion obtained by dispersing binder resin fine particles containing an internal additive (in particular, release agent) in an aqueous medium, if necessary

(3) Preparing of a dispersion of a binder resin fine particle by emulsion polymerization

(4) Mixing of the dispersion of the colorant fine particle with the dispersion of the binder resin fine particle, and agglomerating, associating, and fusing the colorant fine particle and the binder resin fine particle, to form a toner base particle

(5) Filtering of the toner base particle from a dispersion system (aqueous medium) of the toner base particle and removing of a surfactant and the like

(6) Drying of the toner base particle

(7) Adding of an external additive to the toner base particle

In a case where a toner is produced by the emulsion polymerization aggregation method, the binder resin fine particle obtained by the emulsion polymerization method may have a multi-layered structure including two or more layers formed of a binder resin that have different compositions. The binder resin fine particle having such a structure, for example, a two-layered structure, can be obtained by a method in which a dispersion of a binder particle is prepared by an emulsion polymerization treatment (first stage polymerization) according to a conventional method, a polymerization initiator and a polymerizable monomer are added to the dispersion, and the system is subjected to a polymerization treatment (second stage polymerization). The same applies to a binder resin fine particle having a three-layered structure, that is, the binder resin fine particle having a three-layered structure can be obtained by a method in which a polymerization initiator and a polymerizable monomer are further added to a dispersion, and the system is subjected to a polymerization treatment (third stage polymerization).

In an embodiment of the present invention, when the third stage polymerization is performed, a release agent is included in the dispersion used in the second stage polymerization. Such an embodiment can efficiently achieve a desired effect of the present invention.

In addition, a toner particle having a core-shell structure can be obtained by the emulsion polymerization aggregation method. Specifically, for the toner particle having a core-shell structure, first, a core particle is prepared by agglomerating, associating, and fusing a binder resin fine particle for a core particle and a colorant fine particle. Subsequently, a binder resin fine particle for a shell layer is added to a core particle dispersion to agglomerate and fuse the binder resin fine particles for a shell layer to a surface of the core particle, thereby forming a shell layer covering the surface of the core particle. As a result, the toner particle having a core-shell structure can be obtained.

In addition, an example of the production method of the toner of present invention by using a pulverization method is described below.

(1) Mixing of a binder resin, a colorant, and, if necessary, an internal additive with each other with a Henschel mixer or the like

(2) Kneading of the obtained mixture while heating with an extrusion kneader or the like

(3) Coarsely pulverizing of the obtained kneaded matter with a hammer mill or the like, and then performing of a pulverization treatment with a turbo mill pulverizer or the like

(4) Forming of a toner base particle by a fine powder classification treatment of the obtained kneaded matter with, for example, an air flow classifier using a Coanda effect

(5) Adding of an external additive to the toner base particle

The embodiments to which the present invention is applicable are not limited to the embodiment described above, and may be appropriately changed without departing from the spirit of the present invention.

### EXAMPLES

Hereinafter, the present invention will be described in more detail with reference to examples and comparative examples. However, the present invention is not limited to the following examples. In addition, unless otherwise noted, each operation is performed at room temperature (25° C.). In the examples, the description of “part(s)” or “%” may be used, but unless otherwise noted, it indicates “part(s) by mass” or “% by mass”.

### Production of Toner

### Preparation of Amorphous Resin Fine Particle Dispersion (Amorphous Dispersion) X1

(1) First Stage Polymerization

To a 5 L reaction vessel equipped with a stirrer, a temperature sensor, a condensing tube, and a nitrogen introducing device, 8 parts by mass of sodium dodecyl sulfate and 3,000 parts by mass of ion exchange water were charged, and an internal temperature of the reaction vessel was raised to 80° C. while performing stirring at a stirring rate of 230 rpm under a nitrogen flow. After the temperature was raised, an aqueous solution in which 10 parts by mass of potassium persulfate was dissolved in 200 parts by mass of ion exchange water was added to the obtained mixed solution, and the temperature of the obtained mixed solution was set to 80° C. again. A monomer mixed solution 1 formed of the following composition was added dropwise to the mixed solution over 1 hour, and then polymerization was performed by performing heating of the mixed solution at 80° C. for 2 hours and performing stirring, thereby preparing a resin fine particle dispersion a1.

### Monomer Mixed Solution 1

Styrene 480 parts by mass

n-Butyl acrylate 250 parts by mass

Methacrylic acid 68 parts by mass

(2) Second Stage Polymerization

To a 5 L reaction vessel equipped with a stirrer, a temperature sensor, a condensing tube, and a nitrogen introducing device, a solution in which 7 parts by mass of sodium polyoxyetylene (2) dodecyl ether sulfate was dissolved in 3,000 parts by mass of ion exchange water was charged, the solution was heated to 80° C., 80 parts by mass of the resin fine particle dispersion al (in terms of solid content) and a monomer mixed solution 2 obtained by dissolving a monomer formed of the following composition and a release agent at 90° C. were added to the solution, and mixing and dispersion were performed for 1 hour with a mechanical disperser having a circulation path “CLEARMIX” (manufactured by M Technique Co., Ltd., “CLEARMIX” is a registered trademark of the company), thereby preparing a dispersion containing an emulsion particle (oil particle). The following hydrocarbon wax 1 is a release agent, and a melting point thereof is 83° C.

### Monomer Mixed Solution 2

Styrene 285 parts by mass

n-Butyl acrylate 95 parts by mass

Methacrylic acid 20 parts by mass

n-Octyl-3 -mercaptopropionate 8 parts by mass

Hydrocarbon wax 1 (C80 (manufactured by Sasol Ltd.), melting point: 83° C.) 190 parts by mass

Subsequently, an initiator solution obtained by dissolving 6 parts by mass of potassium persulfate in 200 parts by mass of ion exchange water was added to the dispersion, and polymerization was performed by heating and stirring the obtained dispersion at 84° C. over 1 hour, thereby preparing a resin fine particle dispersion a2.

(3) Third Stage Polymerization

400 parts by mass of ion exchange water was further added to the resin fine particle dispersion a2, mixing was sufficiently performed, a solution obtained by dissolving 11 parts by mass of potassium persulfate in 400 parts by mass of ion exchange water was added to the obtained dispersion, and a monomer mixed solution 3 formed of the following composition was added dropwise thereto under a temperature condition of 82° C. over 1 hour. After the addition dropwise was completed, polymerization was performed by heating and stirring the dispersion over 2 hours, and then the dispersion was cooled to 28° C., thereby preparing an amorphous resin fine particle dispersion (hereinafter, referred to as an “amorphous dispersion”) X1 formed of a vinyl resin (styrene-acrylic resin).

### Monomer Mixed Solution 3

Styrene 307 parts by mass

n-Butyl acrylate 147 parts by mass

Methacrylic acid 52 parts by mass

n-Octyl-3-mercaptopropionate 8 parts by mass

As a result of measuring physical properties of the obtained amorphous dispersion X1, a volume-based median diameter (d₅₀) of an amorphous resin fine particle was 220 nm, a glass transition temperature (Tg) of the amorphous resin fine particle was 46° C., and a weight average molecular weight (Mw) of the amorphous resin fine particle was 32,000.

### Preparation of Hydrocathon Wax 2

A hydrocarbon wax 2 was prepared by mixing FNP0090 (melting point: 90° C.) with HNP0190 (manufactured by NIPPON SEIRO CO., LTD., melting point: 80° C.) at a ratio of 40:60 (w/w). A branching degree of the hydrocarbon wax 2 was 28%.

### Preparation of Hydrocathon Wax 3

A hydrocarbon wax 3 was prepared by mixing C80 (manufactured by Sasol Ltd., melting point: 83° C.) with HNP0190 (manufactured by NIPPON SEIRO CO., LTD., melting point: 80° C.) at a ratio of 15:85 (w/w). A branching degree of the hydrocarbon wax 3 was 50%.

### Preparation of Hydrocathon Wax 4

A hydrocarbon wax 4 was prepared by mixing FNP0090 (manufactured by NIPPON SEIRO CO., LTD., melting point: 89° C.) with HNP0190 (manufactured by NIPPON SEIRO CO., LTD., melting point: 80° C.) at a ratio of 90:10 (w/w). A branching degree of the hydrocarbon wax 4 was 6%.

### Preparation of Hydrocathon Wax 5

A hydrocarbon wax 5 was prepared by mixing FNP0090 (manufactured by NIPPON SEIRO CO., LTD., melting point: 89° C.) with HNP0190 (manufactured by NIPPON SEIRO CO., LTD., melting point: 80° C.) at a ratio of 97:3 (w/w). A branching degree of the hydrocarbon wax 5 was 3%.

### Preparation of Hydrocathon Wax 6

FNP0090 (manufactured by NIPPON SEIRO CO., LTD., melting point: 89° C.) was used as a hydrocarbon wax 6. A branching degree of the hydrocarbon wax 6 was 2%.

### Preparation of Hydrocathon Wax 7

A hydrocarbon wax 7 was prepared by mixing C80 (manufactured by Sasol Ltd., melting point: 83° C.) with HNP0190 (manufactured by NIPPON SEIRO CO., LTD., melting point: 80° C.) at a ratio of 10:90 (w/w). A branching degree of the hydrocarbon wax 7 was 53%.

### Preparation of Amorphous Dispersions X2 to X10

Amorphous resin fine particle dispersions (amorphous dispersions) X2 to X10 each were obtained in the same manner as in the preparation of the amorphous dispersion X1 except that the hydrocarbon wax 1 in the second stage polymerization was changed to a release agent shown in Tables 1 to 3. A mass ratio shown in Table 3 is “% by mass” with respect to a total mass of the release agent.

TABLE 1
Hydrocarbon wax

| Hydrocarbon wax No. | Branching degree (%) |
|---|---|
| Hydrocarbon wax 1 | 15 |
| Hydrocarbon wax 2 | 28 |
| Hydrocarbon wax 3 | 50 |
| Hydrocarbon wax 4 | 6 |
| Hydrocarbon wax 5 | 3 |
| Hydrocarbon wax 6 | 2 |
| Hydrocarbon wax 7 | 53 |

TABLE 2
Ester wax

| Ester wax No. | Kind | Melting point |
|---|---|---|
| Ester wax 1 | Behenyl behenate | 74° C. |
| Ester wax 2 | Stearyl stearate | 66° C. |

TABLE 3
Amorphous resin dispersion

| | Hydrocarbon wax | | Ester wax | |
|---|---|---|---|---|
| Amorphous resin | | Mass | | Mass |
| dispersion No. | No. | ratio (%) | No. | ratio (%) |
| X1 | Hydrocarbon wax 1 | 100 | — | — |
| X2 | Hydrocarbon wax 2 | 100 | — | — |
| X3 | Hydrocarbon wax 3 | 100 | — | — |
| X4 | Hydrocarbon wax 4 | 100 | — | — |
| X5 | Hydrocarbon wax 5 | 100 | — | — |
| X6 | Hydrocarbon wax 1 | 20 | Ester 1 | 80 |
| X7 | Hydrocarbon wax 1 | 95 | Ester 1 | 5 |
| X8 | Hydrocarbon wax 6 | 100 | — | — |
| X9 | Hydrocarbon wax 7 | 100 | — | — |
| X10 | Hydrocarbon wax 4 | 10 | Ester 2 | 90 |

### Synthesis of Crystalline Polyester Resin P1

281 parts by mass of sebacic acid and 283 parts by mass of 1,10-decanediol were added to a reaction vessel equipped with a stirrer, a thermometer, a condensing tube, and a nitrogen introducing device. The inside of the reaction vessel was replaced with thy nitrogen gas, 0.1 parts by mass of Ti(OBu)₄ was added thereto, and the obtained mixed solution was stirred at about 180° C. for 8 hours under a nitrogen gas flow, thereby performing a reaction. Further, 0.2 parts by mass of Ti(OBu)₄ was added to the mixed solution, the temperature of the mixed solution was raised to about 220° C. for 6 hours, and the mixed solution was stirred, thereby performing a reaction. Thereafter, an inner pressure of the reaction vessel was reduced up to 1333.2 Pa, and a reaction was performed under the reduced pressure, thereby obtaining a crystalline polyester resin P1. A number average molecular weight (Mn) of the crystalline polyester resin P1 was 5,500, a weight average molecular weight (Mw) of the crystalline polyester resin P1 was 18,000, and a melting point (Tm) of the crystalline polyester resin P1 was 70° C.

### Preparation of Crystalline Resin Fine Particle Dispersion (Crystalline Dispersion) Y1

In a state where 30 parts by mass of the crystalline polyester resin 1 was melted, the resin was transferred to an emulsifying disperser “Cavitron CD1010” (manufactured by EUROTEC LIMITED) at a transfer rate of 100 parts by mass per minute. At the same time, diluted ammonium water having a concentration of 0.37% by mass was transferred to the emulsifying disperser at a transfer rate of 0.1 L per minute while performing heating at 100° C. with a heat exchanger. The diluted ammonium water was prepared by diluting 70 parts by mass of reagent ammonia water with ion exchange water in an aqueous solvent tank. Then, the emulsifying disperser was operated under conditions of a rotation rate of a rotor of 60 Hz and a pressure of 5 kg/cm (490 kPa), thereby preparing a crystalline resin fine particle dispersion (crystalline dispersion) Y1 formed of the crystalline polyester resin 1 having a solid content of 30 parts by mass. A volume-based median diameter (d₅₀) of the particle of the crystalline polyester resin P1 contained in the crystalline dispersion Y1 was 200 nm.

### Preparation of Colorant Dispersion C1

90 parts by mass of sodium dodecyl sulfate was stirred with and dissolved in 1,600 parts by mass of ion exchange water, and 420 parts by mass of C.I. Pigment Blue 18:3 was gradually added thereto while stirring the solution.

Subsequently, the obtained dispersion was subjected to a dispersion treatment by using a stirrer “CLEARMIX” (manufactured by M Technique Co., Ltd.), thereby preparing a colorant fine particle dispersion (colorant dispersion) C1 in which colorant fine particles were dispersed. As a result of measuring a volume-based median diameter d₅₀ in the colorant dispersion C1 with a microtrac particle size dispersion measuring apparatus “UPA-150” (manufactured by Nikkiso Co., Ltd.), the volume-based median diameter d₅₀ in the colorant dispersion C1 was 150 nm.

### Synthesis of Amorphous Resin s1 for Shell

A monomer mixed solution 6 formed of the following composition containing an amphoteric compound (acrylic acid) was loaded to a dropping funnel. Di-t-butyl peroxide is a polymerization initiator.

### Monomer Mixed Solution 6

Styrene 80 parts by mass

n-Butyl acrylate 20 parts by mass

Acrylic acid 10 parts by mass

Di-t-butyl peroxide 16 parts by mass

In addition, the following raw material monomers for a polycondensation type segment (amorphous polyester segment) were added to a four-necked flask equipped with a nitrogen introducing tube, a dehydration tube, a stirrer, and a thermocouple, and then the mixture was heated and dissolved at 170° C.

Bisphenol A propylene oxide 2 mol adduct 285.7 parts by mass

Terephthalic acid 66.9 parts by mass

Fumaric acid 47.4 parts by mass

Subsequently, the monomer mixed solution 6 was added dropwise to the obtained solution over 90 minutes under stirring, aging was performed for 60 minutes, and then unreacted monomers of the components of the monomer mixed solution 6 was removed from the four-necked flask at a reduced pressure (8 kPa).

Thereafter, 0.4 parts by mass of Ti(OBu)₄ as an esterification catalyst was added to the four-necked flask, the mixed solution in the four-necked flask was heated up to 235° C., a reaction was performed under a normal pressure (101.3 kPa) for 5 hours, and then a reaction was further performed under a reduced pressure (8 kPa) for 1 hour, thereby obtaining an amorphous resin s1 for a shell.

### Preparation of Resin Fine Particle Dispersion for Shell (Dispersion for Shell) S1

100 parts by mass of the amorphous resin s1 for a shell was dissolved in 400 parts by mass of ethyl acetate (manufactured by KANTO CHEMICAL CO., INC.), and then was mixed with 638 parts by mass of sodium lauryl sulfate having a concentration of 0.26% by mass prepared in advance. The obtained mixed solution was subjected to ultrasonic dispersion for 30 minutes under a condition of V-LEVEL of 300 μA with an ultrasonic homogenizer “US-150T” (manufactured by NISSEI Corporation) while performing stirring. Thereafter, in a state where the temperature was raised to 40° C., the mixed solution was stirred for 3 hours under a reduced pressure with a diaphragm vacuum pump “V-700” (manufactured by BUCHI Corporation) so as to completely remove ethyl acetate. Thus, an amorphous resin fine particle dispersion for a shell (a dispersion for a shell) S1 having a solid content of 13.5% by mass was prepared. A volume-based median diameter (d₅₀) of the resin particle for a shell in the dispersion S1 for a shell was 160 nm.

### Production of Toner 1

To a reaction vessel equipped with a stirrer, a temperature sensor, and a condensing tube, 288 parts by mass of the amorphous dispersion X1 (in terms of solid content) and 2,000 parts by mass of ion exchange water were added, and then a pH of the dispersion in the reaction vessel was adjusted to 10 (measuring temperature: 25° C.) by further adding a 5 mol/L sodium hydroxide aqueous solution.

30 parts by mass of the colorant dispersion C1 (in terms of solid content) was added to the dispersion. Subsequently, an aqueous solution obtained by dissolving 30 parts by mass of magnesium chloride as an aggregation agent in 60 parts by mass of ion exchange water was added to the dispersion at 30° C. over 10 minutes under stirring. The obtained mixed solution was heated up to 80° C., and then aggregation was performed by adding 40 parts by mass of the crystalline dispersion Y1 (in terms of solid content) to the mixed solution over 10 minutes.

A particle diameter of the associated particles in the mixed solution was measured with “Coulter Multisizer 3” (manufactured by Beckman Coulter, Inc.), and then 37 parts by mass of the dispersion S1 for a shell (in terms of solid content) was added to the mixed solution over 30 minutes at the time at which the volume-based median diameter d₅₀ of the particle reached 6.0 μm. At the time at which a supernatant of the obtained reaction solution became transparent, an aqueous solution obtained by dissolving 190 parts by mass of sodium chloride in 760 parts by mass of ion exchange water was added to the reaction solution to terminate the particle growth.

Further, the reaction solution was heated and stirred at 80° C. to allow fusion of the particles to proceed. The particle in the reaction solution was measured with a measuring apparatus “FPIA-2100” (manufactured by Sysmex Corporation) (HPF detect number of 4,000), and then the reaction solution was cooled to 30° C. at a cooling rate of 2.5° C./min at the time at which an average circularity of the particles reached 0.945.

Subsequently, the particle was separated from the cooled reaction solution and then dehydrated, an obtained cake was washed by repeating re-dispersion in ion exchange water and solid solution separation 3 times, and then drying was performed at 40° C. for 24 hours, thereby obtaining a toner base particle B1.

To 100 parts by mass of the toner base particle B1, 0.6 parts by mass of hydrophobic silica (number average primary particle diameter=12 nm, hydrophobicity=68) and 1.0 part by mass of hydrophobic titanium oxide (number average primary particle diameter=20 nm, hydrophobicity=63) were added, the mixture was mixed at 32° C. and a rotary blade circumferential speed of 35 mm/sec for 20 minutes with a “Henschel mixer” (manufactured by NIPPON COKE & ENGINEERING CO., LTD.), and then coarse particles were removed using a sieve having a mesh size of 45 μm. Such an external additive treatment was performed to produce a toner 1 which is an aggregate of electrostatic latent image developing toner particles 1.

A ferrite carrier having a volume average particle diameter of 32 μm covered with an acrylic resin was added to and mixed with the toner particle 1 so that a concentration of the toner particle became 6% by mass. Thus, a developer 1 which is a double-component developer containing the toner 1 was prepared.

### Production of Toners 2 to 10

Toners 2 to 10 each were produced in the same manner as in the production of the toner 1 except that the amorphous dispersion X1 was changed to amorphous dispersions X2 to X10 shown in Table 3, and developers 2 to 10 were further prepared.

### Evaluation Method

### Adhesiveness of Release Agent

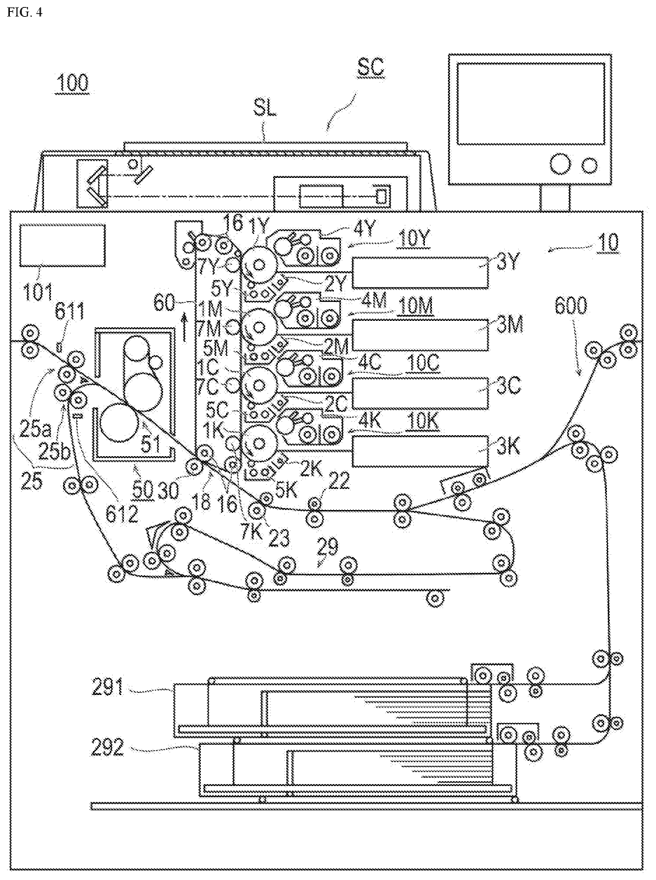

A commercially available color multifunction printer bizhub PRESS C1100 (manufactured by Konica Minolta, Inc.) was modified so that surface temperatures of an upper fixing belt and a lower fixing roller in a fixing apparatus were able to be changed within a range of 140 to 220° C. and within a range of 120 to 200° C., respectively. The respective developers were sequentially mounted on the modified printer, a solid image having a toner adhesion amount of 8.0 g/m² was formed on a rough paper Hammermill tidal (manufactured by Hammermill) under a normal temperature and normal humidity environment (temperature: 20° C., humidity: 50% RH), and then a fixing treatment was performed. A fixing rate during the fixing treatment was 460 mm/sec, a fixing temperature (the surface temperature of the upper fixing belt) was set to an under offset temperature+15° C. An adhesion state of the wax to a conveying roller after 100 sheets were printed out was visually evaluated according to the ranks into 10 levels as described below, and a rank of 7 or higher was rated as acceptable. Specifically, for the adhesion state of the wax to the conveying roller, the wax that adheres to a conveying roller 25 illustrated in FIG. 4 of the present application (FIG. 2 of Japanese Patent Application Laid-Open No. 2018-31921) was visually evaluated according to the ranks.

Ranks 10 and 9: No wax adhesion is observed at all

Ranks 8 and 7: Slight wax adhesion is observed, but there is no problem in the quality

Ranks 6 to 1: Wax adhesion is observed, and thus, it is practically unacceptable

### Gloss Unevenness

A commercially available color multifunction printer bizhub PRESS C1100 (manufactured by Konica Minolta, Inc.) was modified so that surface temperatures of an upper fixing belt and a lower fixing roller in a fixing apparatus were able to be changed within a range of 140 to 220° C. and within a range of 120 to 200° C., respectively. The respective developers were sequentially mounted on the modified printer, a solid image having a toner adhesion amount of 8.0 g/m² was formed on a rough paper Hammermill tidal (manufactured by Hammermill) under a normal temperature and normal humidity environment (temperature: 20° C., humidity: 50% RH), and then a fixing treatment was performed. A fixing rate during the fixing treatment was 460 mm/sec, a fixing temperature (the surface temperature of the upper fixing belt) was set to an under offset temperature+15° C. Concentration unevenness and gloss unevenness of the obtained solid image were visually evaluated according the ranks as described below.

⊙: Concentration unevenness or gloss unevenness is not observed at all

o: Slight concentration unevenness or gloss unevenness is observed, but there is no problem in the quality

x: Concentration unevenness or gloss unevenness is observed, and thus, it is practically unacceptable

### Gloss Memory

A multifunction printer bizhub PRO (registered trademark) C6501 (manufactured by Konica Minolta, Inc.) was modified so that, in a fixing apparatus, a pressure in a nip region was able to be changed, a surface temperature of a heat roller for fixing (fixing roller) was able to be changed within a range of 100 to 210° C., and a process rate (nip time) was able to be changed, and the respective developers produced from the toners were mounted on the multifunction printer. For each developer produced from each of the toners, a fixing test in which an image for gloss memory evaluation having the toner adhesion amount of 8 g/m² is output on an A3-sized coated paper Esprit C (209 g/m²) (manufactured by NIPPON PAPER INDUSTRIES CO., LTD.) under a normal temperature and normal humidity environment (temperature: 20° C., humidity: 50% RH), was repeated while changing a set fixing temperature from 160° C. to 200° C. in 10° C. increments under conditions of a nip pressure of a fixer of 238 kPa and a nip time of 25 milliseconds (process rate of 480 mm/s). Five images having levels different in gloss memory were prepared and compared with each other to perform evaluation according to the ranks (the higher the number, the higher the quality). An average value of the ranks in the entire temperature region was 4 or higher, and thus, the images were acceptable. Evaluation criteria are shown below. Here, glossiness was measured with a glossimeter “GMX-203” (manufactured by MURAKAMI COLOR RESEARCH LABORATORY CO., LTD.) under selection of a measuring angle type of 75° in accordance with JIS Z 8741.

5: A difference in glossiness at locations where the gloss memory occurs is less than 2

4: A difference in glossiness at locations where the gloss memory occurs is 2 or more and less than 4

3: A difference in glossiness at locations where the gloss memory occurs is 4 or more and less than 6

2: A difference in glossiness at locations where the gloss memory occurs is 6 or more and less than 8

1: A difference in glossiness at locations where the gloss memory occurs is 8 or more

The results are shown in the following table.

TABLE 4

| | Toner | | | | | | |
|---|---|---|---|---|---|---|---|
| | | Amorphous | Exothermic peak | Half-value | Evaluation result | | |
| | Toner | resin | temperature | width | WAX | Gloss | Gloss |
| | No. | dispersion No. | (° C.) | (° C.) | adhesiveness | unevenness | memory |
| Example 1 | 1 | X1 | 80 | 7 | 10 | ⊙ | 5 |
| Example 2 | 2 | X2 | 78 | 7 | 9 | ⊙ | 5 |
| Example 3 | 3 | X3 | 73 | 7 | 8 | ⊙ | 4 |
| Example 4 | 4 | X4 | 70 | 6 | 9 | ◯ | 5 |
| Example 5 | 5 | X5 | 72 | 4 | 7 | ◯ | 5 |
| Example 6 | 6 | X6 | 67 | 5 | 7 | ◯ | 4 |
| Example 7 | 7 | X7 | 78 | 7 | 9 | ◯ | 5 |
| Comparative | 8 | X8 | 88 | 4 | 6 | X | 4 |
| Example 1 | | | | | | | |
| Comparative | 9 | X9 | 82 | 8 | 6 | ◯ | 3 |
| Example 2 | | | | | | | |
| Comparative | 10 | X10 | 58 | 6 | 5 | X | 3 |
| Example 3 | | | | | | | |

Although embodiments of the present invention have been described and illustrated in detail, the disclosed embodiments are made for purposes of illustration and example only and not limitation. The scope of the present invention should be interpreted by terms of the appended claims.

Toners produced in the same manner as of the Examples using a colorant having a dispersion diameter of 95 nm which is calculated as a number mean value of a horizontal Feret diameter in a cross section instead, show good adhesiveness of release agent property of “Rank 7” or more, good gloss unevenness property of “⊙” or “◯” and good gloss memory property of “4” or more. This is because the release agent which is included in the toners contain a hydrocarbon wax having a branching degree of 3 to 52%, and a top temperature of an exothermic peak during cooling of the toner measured by a differential scanning calorimetry is within a range of 60 to 85° C.

The entire disclosure of Japanese patent Application No. 2019-103366, filed on May 31, 2019, is incorporated herein by reference in its entirety.

What is claimed is:

1. An electrostatic latent image developing toner comprising:
a binder resin; a release agent; and a colorant,
wherein the binder resin contains a crystalline resin,
the release agent contains a hydrocarbon wax having a branching degree of 3 to 52%, and
a top temperature of an exothermic peak during cooling of the electrostatic latent image developing toner measured by a differential scanning calorimetry is within a range of 60 to 85° C.

2. The electrostatic latent image developing toner according to claim 1, wherein the release agent contains the hydrocarbon wax having the branching degree of 5 to 30%.

3. The electrostatic latent image developing toner according to claim 2, wherein the branching degree is 10 to 25%.

4. The electrostatic latent image developing toner according to claim 1, wherein the binder resin contains a styrene-acrylic resin.

5. The electrostatic latent image developing toner according to claim 1, wherein a half-value width of the exothermic peak is 7° C. or lower.

6. The electrostatic latent image developing toner according to claim 1, wherein the release agent contains a wax other than the hydrocarbon wax, and
a content of the wax other than the hydrocarbon wax is 90% by mass or less with respect to a total mass of the release agent.

7. The electrostatic latent image developing toner according to claim 6, wherein the content of the wax other than the hydrocarbon wax is less than 5% by mass with respect to the total mass of the release agent.
